(19) United States
(12) Patent Application Publication
(10) Pub. No.: US 2026/0094178 A1
(43) Pub. Date: Apr. 2, 2026

(54) SYSTEM FOR AND METHOD OF ENGAGING RESIDENTS AND PROPERTY OWNERS AND PROVIDING RESIDENTS WITH AN OWNERSHIP STAKE IN REAL ESTATE

(71) Applicant: Seed InvestCo, LLC, Atlanta, GA (US)

(72) Inventors: Randy Etheredge, Atlanta, GA (US); Sam Peskin, Atlanta, GA (US); Daniel Dorfman, Atlanta, GA (US); Larry Dorfman, Atlanta, GA (US)

(21) Appl. No.: 19/346,371

(22) Filed: Sep. 30, 2025

Related U.S. Application Data
(60) Provisional application No. 63/701,571, filed on Sep. 30, 2024.

(51) Int. Cl. G06Q 30/0207; G06Q 10/0631; G06Q 30/0214

(52) U.S. Cl. CPC G06Q 30/0216; G06Q 10/06311; G06Q 30/0214

(57) ABSTRACT

A system and method is provided for enabling a first party to provide awards to a second party in exchange for the second party completing one or more challenges, for example, over a predetermined period of time, thereby incentivizing the second party to complete challenges, actions, tasks, or steps over predetermined periods of time in exchange for the first party providing awards.

### CROSS-REFERENCE TO RELATED APPLICATIONS

This Application claims the benefit of U.S. Provisional Application No. 63/701,571 filed Sep. 30, 2024, the contents of which is incorporated herein in its entirety.

### FIELD OF TECHNOLOGY

The present disclosure generally relates to a system or platform for, and method of, providing one or more rewards by a first party to a second party in exchange for the second party completing one or more challenges over one or more predetermined periods of time.

The present disclosure also generally relates to a system for, and method of, providing a provider platform for a first party, the platform configured to collect data from a second party based on a completion of one or more challenges by the second party over one or more predetermined periods of time, generate a database for reviewing and/or assessing the one or more completed challenges, and determining and/or distributing one or more awards to the second party based on the one or more completed challenges.

In some example embodiments, the present disclosure generally relates to systems for, and methods of, assessing a status of parts of a property occupied by a tenant and communicating the status to a property owner, and more particularly, assessing a status of parts of a property occupied by a tenant by providing data, such as image data, which is received from the tenant, and more particularly, received periodically from the tenant, to the property owner in exchange for an award to the tenant.

The present disclosure also generally relates to systems for, and methods of, providing a provider platform configured to collect data (e.g., tenant data, tenant submission data, property owner data, reviews of properties and/or property owners, etc.) and generate a database for reviewing and/or assessing one or more tenants, properties, property owners, opportunities for tenant-property owner relationships (e.g., leasing or rental opportunities), etc.

### BACKGROUND OF THE INVENTION

Conventionally, a renter or tenant enters into an agreement (e.g., lease, rental agreement) with a landlord or property owner to occupy a property for a period of time. A tenant commonly provides a security deposit to the property owner to compensate the property owner for possible loss or damage, or at least a portion thereof. Beginning at the time of Move-In, the tenant begins occupying the property for a predetermined period of time (i.e., the occupied period) in which the tenant occupies the property in exchange for payment of the agreed upon rent or lease amount. The occupied period ends, either at the end of the rental/lease term whereupon the tenant vacates the property (i.e., Move-Out), or in some circumstances, whereupon the tenant vacates the property prior to the end of the rental/lease term (i.e., early termination and Move-Out).

### BRIEF SUMMARY OF THE INVENTION

The present invention recognizes that absent a need to enter the property for repairs, maintenance, or other issues, the property owner typically may have little or no opportunity to view or inspect the property during the occupied period, and in many instances, not until after the occupied period ends (i.e., Move-Out). While a property owner may have a right to schedule in-person inspections during the occupied period, these inspections can prove costly and challenging to coordinate while the property is occupied. As a result, prior to Move-Out, the property owner typically may have little or no information about the condition of the property (or parts thereof) or an amount of any damage, wear, repairs or other upkeep (i.e., “hidden repairs” or “unknowns”) needed on a part of the property, such as cleaning, re-painting, repairs, replacement, landscaping or lawn care etc. Additionally, the property owner may have limited or no information about the amount of time to complete these items, that may be needed to prepare the property for a new tenant (i.e., to “turn over” or “flip” the property for occupancy by a new tenant under a new agreement). After Move-Out, the property owner may, for the first time, learn about the condition of the property or discover damage, wear, repairs or other upkeep needed on a part of the property, such as cleaning, re-painting, repairs, replacement, landscaping or lawn care, etc. The property owner may need to use some or all of the tenant's security deposit to cover the loss or damage.

In view of these potential “hidden repairs” or “unknowns” to the property owner during the occupied period, the present invention recognizes that a property owner may expect that the costs of any damage, wear, repairs or other upkeep needed on a part of the property, such as cleaning, re-painting, repairs, replacement, landscaping or lawn care etc., will exceed the amount of the security deposit, and therefore, may withhold refunding any part of the tenant's security deposit until the condition of the property can be assessed and a cost of any damage or repairs is calculated.

On the other hand, the present invention recognizes that the tenant also may have limited or no information about how much of their security deposit will be returned by the property owner, or for that matter, how quickly the tenant may expect to receive any portion or all of the security deposit, even if a refund is provided at some point. A tenant may expect that they will have only a portion of their security deposit, or in some cases none of their deposit, returned at the end of the occupied period. Based on this uncertainty, the tenant may lack motivation, or have little motivation, to report repairs or maintenance that may be needed to the property owner during the occupied period (i.e., “hidden repairs” or “unreported repairs”). For example, a tenant may simply avoid reporting damage or maintenance to the property owner if they expect to lose their security deposit any way. In some cases, a tenant may attempt to hide damage or maintenance from the property owner if they expect to lose their security deposit. In other examples, a tenant may avoid reporting damage or maintenance to the property owner in situations where those repairs or maintenance may not disrupt the tenants use of the property, may be cosmetic in nature, or simply are acceptable to or tolerable by the tenant during the occupied period. As a result, one or more repairs or maintenance items may remain unknown or hidden from the property owner throughout the occupied period. This can result in unexpected or extended downtime during which the property is unoccupied or cannot be occupied by a tenant, thereby resulting in a decrease in revenue, or lost revenue, to the property owner during this time.

The present invention further recognizes that such circumstances and expectations may lead to tension between the property owner and the tenant throughout the occupied period and each party may have little willingness to cooperate with the other party. During Move-Out, tenants and property owners also may waste time on security deposit disputes and manual processes, which may result in taking a longer time to complete the Move-Out process, which in turn may hamper referrals, renewals, and reviews, of the property, among other things. Such circumstances and expectations also may lead to unfavorable trends for tenants and property owners across the property rental industry. For example, if property owners come to expect damages will exceed the security deposit amounts received from tenants, then property owners may increasingly look for other ways to create efficiencies, reduce costs, etc., such as increasing security deposit requirements over time, which may result in potentially long term effects on future tenants and the industry. In other examples, property owners may look to limit or restrict some services provided during the occupied period to only basic or necessary services or maintenance. In still other examples, a property owner may provide less flexibility to tenants during Move-In and/or Move-Out, and/or provide more restrictions on a tenant's use of the property during the occupied period.

The present invention further recognizes that such time-consuming deposit disputes and slow manual in-person inspection processes may delay or prolong move-outs for tenants and/or property owners, and/or may hamper reviews, referrals, and renewals for the property and/or property owners.

The present invention further recognizes that, conventionally, attracting and acquiring tenants generally includes advertising, lowering rent/lease amounts, and/or offering discounts and property owners typically compete against other property owners to promote the same types of offerings to prospective tenants.

These problems and others are addressed by the present invention, exemplary embodiments of which comprise a system for, and method of, assessing a status of one or more parts of one or more properties occupied by one or more tenants and communicating the status to one or more property owners. In this way, the present invention can transform the “landlord-tenant” relationship into a partnership (i.e., a cooperative partnership) that is mutually beneficial to both parties. That is, tenants Move-In as so-called partners to the property, thereby aligning their interests with the property owner's interests and success of the property.

In an exemplary embodiment, a system for, and method of, assessing a status of one or more parts of one or more properties occupied by one or more tenants includes one or more tenants providing one or more tenant submissions to one or more property owners in exchange for one or more awards. In an exemplary embodiment, the one or more tenant submissions includes one or more image data, including one or more of photo or image data, and/or video or video image data with or without audio data, and/or voice or audio data, and/or other information, such as one or more responses to a questionnaire, a notification of a status and/or condition of an item of the property, a move-in checklist identifying a status and/or condition of one or more items of the property, a move-out checklist identifying a status and/or condition of an item of the property, along with other dsubmissions, such as one or more comments, notes, rankings (e.g. severity rankings), etc. related to a status and/or condition of one or more items of the property, among other things. The responses can include data related to or representative of one or more of image data (e.g., still image or video image), audio data, textual data, and/or other input data, such as a user interface with a graphical widget, such as multiple choice, checkbox, slide, percentage, ranking, etc.

In this way, the exemplary embodiments can enable a tenant to do “tenant-led” or “renter-led” photo and/or video “check-ins” or “walk-throughs” and then submit the photo, video, textual, and/or audio check-ins to be communicated to the property owner to assess the status of a property, damage, etc. For example, a tenant can record videos, capture still images, provide textual data (e.g., typed text) and/or audio comments/descriptions (e.g., captured audio data/recordings of spoken words), and/or complete questionnaires/surveys while walking room to room, showing one or more parts, or all parts or areas, of the rental property.

The exemplary embodiments can enable a tenant, for example, to identify and capture image data related to one or more repairs or other maintenance that may be needed during the occupied period and to communicate the status of the property to the property owner in exchange for one or more awards. Moreover, the present invention can determine the one or more awards provided by the property owner to the tenant based on an assessment of a condition of the image data provided by the tenant to the property owner. In essence, the present invention provides a tenant with an interest (e.g., an equity/investment stake) in the property, and more particularly, in a condition of the property.

The present invention can provide important advantages of increasing or maintaining property value and increasing profit and lost margins, among other things, by incentivizing tenants to actively monitor the status of the property and take care of the property. Such engaged renters can lead to better-maintained properties, thereby resulting in higher property value. The present invention can provide real-time feedback to property owners to assist property owner's ability to handle multiple properties easily while ensuring satisfaction of tenants, thereby streamlining operations of property owners. The present invention can facilitate an engaged community that enables tenants and property owners to align their interests, as well as staff and tenants and/or property owners, thereby fostering improved tenant relationships, improved tenant retention, and reduced vacancy of properties.

For example, during Move-In, the exemplary embodiments of the invention can provide a streamlined Move-In process for both the tenant and the property owner and enable the tenant to build wealth as a so-called partner in the property, thereby aligning the tenant's interest with the success of the property, which can be mutually beneficial for the tenant and the property owner.

During the occupied period, a tenant who partners with a property owner through the exemplary embodiments of the invention can occupy the property in a manner similar to owning the property and can be motivated to identify or catch items early, for example, before they develop into larger and more costly problems and time-consuming repairs. By catching or identifying issues, such catching or identifying small issues early, a tenant may help with preventative maintenance, reduce the need for in-person checks/inspections, and take overall better care of the property, which can be mutually beneficial for the tenant and the property owner. By providing the tenant with one or more awards based on the status and/or condition of the property, the tenant has a mutual interest with the property owner in seeing that the property is in good condition, resulting in more favorable living conditions for the tenant and a more cooperative relationship between the tenant and the property owner, thereby increasing retention of tenants because tenants may be more inclined to stay longer (e.g., renew their lease, avoid early termination, etc.) driven by their desire to participate in a wealth building program with the property owner. In turn, such increased retention can increase profitability for the property owner. The present invention also can provide or improve homeowner education by enabling tenants to gain valuable homeownership skills through video walk-throughs and maintenance education.

During Move-Out, a tenant who partners with a property owner through the exemplary embodiments of the invention may close out the Move-Out process more quickly and efficiently and work in a more cooperative manner with the property owner. By providing the tenant with one or more awards based on the status and/or condition of the property, the tenant has a mutual interest with the property owner in seeing that the property is in good condition at the time of Move-Out, thereby reducing or minimizing repairs, maintenance, and associated turnover costs resulting in lower “turn costs” and reduced “turn times” for property owners, which increases profitability for property owners. By providing transparency and helping tenants maintain properties, the present invention also can enable tenant's to increase or maximize the amount of their deposit that is returned upon move-out.

In another exemplary embodiment, a system for, and method of, assessing a status of one or more parts of one or more properties occupied by one or more tenants can include one or more tenants providing further data to one or more property owners in exchange for one or more awards. For example, the further data can include one or more textual data (e.g., typed text) and/or audio data (e.g., captured audio recordings of spoken words) responses to a questionnaire, a notification of a status and/or condition of an item of the property, a Move-In checklist (e.g., move-in walk-through checklist) identifying a status and/or condition of one or more items of the property, a Move-Out checklist (e.g., move-in walk-through checklist) identifying a status and/or condition of an item of the property, along with other submissions, such as one or more comments, notes, rankings (e.g. severity rankings), etc. related to a status and/or condition of one or more items of the property.

The examples are not limited to tenant submissions related to physical items of the property and can include, for example, tenant submissions regarding interactions with staff and other members of their community, services, etc. That is, the system can enable a property owner to create a request for one or more types and/or content of one or more tenant submissions to be requested from the tenant, for example, in Move-In, periodic, and/or Move-Out submissions, etc., in exchange for one or more awards. By providing the tenant with one or more awards based on, for example, interactions with staff and other members of their community, the tenant has a mutual interest with the property owner in forming better relationships with staff and other members of their community, and to interact positively with staff and other members of their community in exchange for one or more awards.

In some examples, other considerations may be assessed in determining or calculating awards, such as a tenant's payment and/or history of payment of rent on time, being a good neighbor, receiving no complaints from other neighbors or staff, etc. In some examples, a tenant's timely payment of rent can be considered a tenant submission for purposes of determining or calculating awards. In examples, a tenant's timely payment of rent can be considered a tenant submission for purposes of reporting to one or more credit bureaus or agencies, which may favorably impact a tenant's credit score.

According to the exemplary embodiments, the preset invention can enable tenants to earn rewards and/or invest, thereby turning the action of renting/leasing a property into a wealth-building opportunity for a tenant.

The systems and methods according to the present invention also can provide property owners with access to a community of tenants (e.g., current and potential tenants) eager for wealth-building opportunities, thereby improving marketing power for property owners. For example, the present invention can generate and provide access to a database having one or more types of data related to a plurality (e.g., thousands) of tenants.

Additionally, the exemplary embodiments of the invention can provide accountability by enabling tenants to provide reviews about property owners and/or properties, track maintenance, etc. for use by or educating/informing other tenants or prospective tenants.

The present invention provides property owners with the opportunity to engage tenants throughout the occupied period, such as through tenant submissions and awards issued to tenants. As a result, the exemplary embodiments of the invention enable a property owner to be actively engaged with the tenant in retaining tenants (e.g., retaining good tenants). For example, the exemplary embodiments can enable property owners to develop or build trust of tenants by offering awards, credit building, financial education, renewal rewards, etc., thereby keeping residents longer as the tenants grows wealth.

For purposes of this disclosure, the terms “tenant,” “resident,” and “renter” as used interchangeably herein mean a party (or prospective party) to an agreement to lease or rent a property for a period of time (e.g., a predetermined period of time). The terms “tenant,” “resident,” and “renter” can mean a related party to such an agreement (e.g., sub-tenant, sublessor, occupant, family member, etc.)

The terms “Property Owner,” “property managers,” and “landlord” as used interchangeably herein mean a party related to an agreement for a tenant to lease or rent a property for a period of time (e.g., a predetermined period of time).

The term “occupied period” as used herein can mean the period of time beginning on the effective date of the agreement (rental/lease agreement/landlord-tenant agreement), during which the tenant moves in and occupies the property for a predetermined period of time (i.e., occupied period) in exchange for payment of the agreed upon rent or lease amount in accordance with the term of the agreement.

The terms “turnover,” “real estate turnover,” “rental turnover,” or “tenant turnover” as used interchangeably herein mean the period between when a tenant moves out of a property and a new tenant moves in, during which time the property is prepared for the new tenant, including for example addressing any damage, wear, repairs or other upkeep needed on a part of the property, such as cleaning, re-painting, repairs, replacement, landscaping or lawn care etc.

The term “tenant submission” as used herein can mean one or more of image data, including one or more of photo or image data, and/or video or video image data with or without audio data, and/or voice or audio data, and/or other information, such as one or more responses to a questionnaire, a notification of a status and/or condition of an item of the property, a move-in checklist identifying a status and/or condition of one or more items of the property, a move-out checklist identifying a status and/or condition of an item of the property, along with other submissions, such as one or more comments, notes, rankings (e.g. severity rankings), etc. related to a status and/or condition of one or more items of the property, among other things. The responses can include data related to or representative of one or more of image data (e.g., still image or video image), audio data, textual data, and/or other input data, such as a user interface with a graphical widget, such as multiple choice, checkbox, slide, percentage, ranking, etc.

The terms “employee” or “candidate for employment” as used herein mean a party employed by another, for example, for wages or salary, or a party (or prospective party) to an employment agreement or a candidate to be employed by another, for example, The terms “employee” or “candidate for employment” can mean a related party to such an agreement

The term “employer” as used herein means a party, entity, person, company, or the like that provides a job, for example, paying wages or a salary, to another party, such as one or more people (e.g., employees, contract workers, etc.), a party related to an agreement for employment, or the like, for a period of time (e.g., a predetermined period of time).

In some examples, the computing technology (e.g., cloud-based computing technology) can run machine learning algorithms with inputs of the one or more tenant submissions (e.g., image data including one or more still images, one or more video images, and/or one or more frames of one or more video images) to determine a condition of one or more items associated with a property, for example, one or more items associated with a region, area (e.g., interior or exterior), room, fixture, furniture (e.g., furniture provided by the property owner for the use of the tenant during the term), door, appliance, structure, mechanical/electrical system, or other part of the property, or one or more portions, parts, or components thereof of the property. The one or more machine learning processes can include, for example, one or more neural networks, such as transformer neural networks, NVIDIA DeepStream technology, etc. The one or more neural networks are not limited to any particular neural networks and can include one or more neural networks, such as transformer neural networks, and/or other technology for analyzing one or more of collected image data (e.g., video image data, frames of video image data, etc.), audio data (e.g., captured audio recordings of spoken words), textual data (e.g., sequential text), etc. and/or one or more datasets including such data.

The term “award” or “reward” as used interchangeably herein can mean any financial or other award including, for example, one or more of a rebate, cash or other monetary items having a fixed value, credits, debt reimbursement, discounts, products, services, ownership interest/equity investment stake in the property or another property or in a trust or fund for one or more properties such as share(s) in Real Estate Investment Trusts (“REITs”), stocks, etc., cryptocurrency, digital tokens, and/or other financial instruments having a fixed or variable value, or the like. In other examples, an award can include other opportunities for the tenant and/or property owner (e.g., made available through the provider platform). For example, an award can include one or more of financial offerings, marketplace offerings, access to investment funds, debt consolidation (e.g., enabling tenants to consolidate debit into a single loan with moderate interest rates, using a unique platform score beyond a typical credit score), savings (e.g., high yield savings including offering tenants access to FDIC insured, high yield savings alternative to a traditional savings account), credit, credit facilitation (e.g., enabling tenants to unlock access to credit with unique rewards tailored for renting and home ownership, credit cards, lending options, insurance options/discounts (e.g., renters, auto, life, disability, and/or other insurance), mortgage options/discounts, and/or community rates (e.g., community group rates).

In an example, the system can be configured to add (e.g., automatically add) a portion or all of one or more monetary awards to a security deposit of the tenant to provide additional protection for the tenant and the property owner.

In some examples, the system can be configured to utilize awards and/or enhanced profits to make (e.g., automatically make) a contribution/donation (e.g., from one or more tenants, one or more property owners, and/or the provider platform) to the tenant community (e.g., a community fund, homeowner's association, etc.) for every one or more quotations obtained through the provider platform.

In some examples, the system can be configured to utilize awards and/or enhanced profits to provide lending capital used to empower home ownership programs and tenant wealth building opportunities across one or more regions of the country.

In some examples, the system can be configured to utilize one or more tenant submissions for investing in Environmental, Social, and Governance (ESG) programs that prioritize environmental issues, social issues, and corporate governance. In examples, the system can be configured to utilize one or more tenant submissions to improve or open opportunities for ESG funding (e.g., government funding) to be deployed to better help those that ESG funds/investing are intended to help.

In some examples, the system can be configured to utilize one or more tenant submissions to maintain or achieve compliance needs (e.g., government and/or agency compliance) and improve an impact (e.g., social impact) being made for tenants across a portfolio.

Another exemplary embodiment of the invention relates to systems for, and methods of, providing a provider platform configured to collect data (e.g., tenant data, tenant submission data, tenant reviews/ranking/statistics, property owner data, reviews/rankings of properties and/or property owners, etc.) and generate a database for reviewing and/or assessing one or more tenants, properties, property owners, opportunities for tenant-property owner relationships (e.g., leasing or rental opportunities), etc.

In some examples, the exemplary embodiments are directed to a system and method for engaging tenants and property owners, assessing property status via tenant submissions (including, for example, images, video, audio, and/or text, among other things), and awarding tenants (e.g., one or more awards) for participation. The system includes a provider platform, tenant application, and property owner application, implemented via computing devices and servers. The one or more awards may include one or more of financial incentives, investment stakes, and/or other benefits, among other things, for example as described in the examples herein. In some example embodiments, the systems and methods leverage databases and, in some examples, neural networks for processing data in the databases for assessments and matching.

The invention is implemented via a combination of hardware (e.g., servers, computing devices, image/audio capture devices, and/or input devices, among other things) and software (e.g., specialized platforms, applications, and/or algorithms), thereby transforming general-purpose computers into special-purpose systems for engagement between one or more first parties and one or more second parties, such as property management and tenant engagement

The system solves a real-world problem of improving property management, tenant engagement, and/or wealth-building opportunities, among other things, by incentivizing one or more parties, such as tenants, to report property status, facilitate efficient communication and assessment between parties, and/or perform and/or complete one or more challenges, for example, over one or more predetermined periods of time in exchange for one or more awards.

The exemplary systems and methods do not merely collect or manipulate data from a first party and/or a second party, but rather, the exemplary embodiments described herein processes various forms of data (e.g., images, audio, text, questionnaires, surveys, challenges, among other things), which are used, for example, to assess property status, determine awards, and/or distribute awards, among other things based on the one or more completed challenges, and in some examples, to incentivize and/or illicit completion of one or more additional challenges based on the one or more completed challenges, property status, determined awards, and/or distributed awards, among other things based on the one or more completed challenges. In this way, the exemplary algorithms, methods, and processes improve and transform general-purpose computers into special-purpose computers for a system of and method for incentivizing a second party, such as a tenant, renter, employee, customer, patron, and/or participant in an organization, among other second parties, to complete one or more challenges, actions, tasks, and/or steps over one or more predetermined periods of time in exchange for a first party, such as a property owner, employer, organization, and/or business, among other first parties, to provide one or more awards, such as one or more wealth building rewards, among other rewards.

An exemplary embodiment relates to a system for assessing a status of a property occupied by a tenant, comprising a provider platform comprising one or more servers, each server including one or more processors and one or more non-transitory computer-readable storage mediums storing instructions that, when executed, cause the processors to receive, via a tenant application executed on a tenant computing device, tenant submissions comprising image data, audio data, textual data, and questionnaire responses relating to the status or condition of one or more items of the property; process the tenant submissions to assess the status or condition of the property; determine an award for the tenant based on the assessment of the property status or condition; and communicate and/or distribute the determined award to the tenant via the tenant application, wherein the system is configured to periodically prompt the tenant for submissions and to store the submissions and assessments in a database accessible to property owners.

Another exemplary embodiment relates to a computer-implemented method for engaging tenants and property owners and providing tenants with an ownership stake in real estate, comprising receiving, by a provider platform, tenant submissions from a tenant application, the submissions including at least one of image data, audio data, textual data, or questionnaire responses regarding the status of a property; processing the tenant submissions to assess the status or condition of the property; determining, by the provider platform, an award for the tenant based on the assessment; providing, by the provider platform, the award to the tenant, wherein the award comprises at least one of a financial incentive, investment stake, or credit toward a security deposit; and storing the tenant submissions and assessment results in a database for review by property owners.

In an example, the tenant submissions include periodic image data captured by an image capturing device of the tenant computing device.

In an example, the award comprises an ownership interest in a real estate investment trust (REIT).

In an example, the method further includes reporting the tenant's timely payment of rent to a credit bureau as part of the tenant submissions.

In an example, the processing of tenant submissions includes applying a neural network to assess the status or condition of the property.

In this way, the exemplary embodiments provide a process and system utilizing specific technological means (e.g., image/audio capture, database, and/or neural networks) to solve one or more real-world property management problems and integrate those specific technological means into one or more practical applications by improving property management, tenant engagement, and/or wealth-building, among other things, and by transforming generic computers into special-purpose systems for improving property management, tenant engagement, and/or wealth-building, among other things.

Another exemplary embodiment relates to a system for assessing and incentivizing tenant participation in property management, comprising (a) a provider platform comprising one or more servers, each server including at least one processor and at least one non-transitory computer-readable storage medium storing instructions that, when executed by the processor, cause the provider platform to (i) receive, via a tenant application executed on a tenant computing device, tenant submissions comprising at least one of image data, audio data, textual data, and questionnaire responses relating to a status or condition of one or more items of a property; (ii) process the tenant submissions by applying at least one assessment algorithm configured to evaluate the status or condition of the property based on the received data; (iii) generate an assessment result indicating the status or condition of the property; (iv) determine an award for the tenant based on the assessment result, wherein the award comprises at least one of a financial incentive, investment stake, or credit toward a security deposit; (v) transmit the assessment result and the determined award to the tenant application for display to the tenant; (vi) store the tenant submissions, assessment results, and award determinations in a database accessible to a property owner application; and (b) a property owner application configured to access the database and review the tenant submissions and assessment results.

A computer-implemented method for engaging tenants in property management and providing incentives, comprising (a) receiving, by a provider platform, tenant submissions from a tenant application, the submissions including at least one of image data, audio data, textual data, or questionnaire responses regarding a status or condition of a property; (b) processing the tenant submissions by executing an assessment algorithm that evaluates the status or condition of the property; (c) generating an assessment result based on the processed submissions; (d) determining, by the provider platform, an award for the tenant based on the assessment result, wherein the award comprises at least one of a financial incentive, investment stake, or credit toward a security deposit; (e) transmitting the assessment result and the determined award to the tenant application; (f) storing the tenant submissions, assessment results, and award determinations in a database accessible to a property owner application.

An exemplary embodiment relates to a non-transitory computer-readable storage medium storing instructions that, when executed by a processor, cause a provider platform to (a) receive tenant submissions from a tenant application, the submissions comprising at least one of image data, audio data, textual data, and questionnaire responses relating to a property; (b) process the tenant submissions using an assessment algorithm to evaluate the status or condition of the property; (c) generate an assessment result and determine an award for the tenant based on the assessment result; (d) transmit the assessment result and award to the tenant application; (e) store the tenant submissions, assessment results, and award determinations in a database accessible to a property owner application.

In another example, the assessment algorithm comprises a neural network trained to identify property defects from image data submitted by the tenant.

In another example, the tenant application is configured to prompt the tenant to submit image data of specific property items at predetermined intervals.

In another example, the award comprises an ownership interest in a real estate investment trust (REIT) managed by the provider platform.

In another example, the provider platform is further configured to report the tenant's timely rent payments to a credit bureau as part of the award determination.

In another example, the assessment algorithm applies a scoring rubric to questionnaire responses to quantify the condition of the property.

In another example, the method further comprises notifying the property owner via the property owner application when the assessment result indicates a maintenance issue.

In another example, the tenant application includes an image capture module configured to automatically tag image data with metadata including time, date, and location.

In another example, the instructions further cause the provider platform to aggregate assessment results from multiple tenants for portfolio-level property analysis.

In another example, the database is configured to store historical assessment results for trend analysis and predictive maintenance scheduling.

In some examples, the exemplary embodiments of the systems and method utilize specific technical features (e.g., neural networks, image capture modules, metadata tagging, and/or scoring rubrics, among other things) and practical steps (e.g., reporting to credit bureaus, portfolio analysis) to solve one or more real-world problems (e.g., property management and/or tenant engagement, among other things) using a specific technological solution.

An exemplary embodiment enables a first party, such as a property owner, among other parties, to provide awards, such as wealth building awards or other awards, to a second party, such as a tenant, among other second parties, in exchange for the second party completing one or more challenges, for example, over one or more predetermined periods of time. In this way, the exemplary embodiments provide a system for and method of incentivizing a second party, such as a tenant, renter, among other second parties, to complete one or more challenges, actions, tasks, and/or steps over one or more predetermined periods of time in exchange for a first party, such as a property owner, among other first parties, to provide one or more awards, such as one or more wealth building rewards, among other rewards.

In an exemplary embodiment, the systems and methods relate to a Wealth Building Rewards (WBR) program for one or more property owners and/or one or more tenants.

The present invention further recognizes that there is a similar need for employers to attract, acquire, and/or retain employees. These problems and others are addressed by the present invention, exemplary embodiments of which comprise a system for, and method of, providing employees and/or employers with the same or similar investment opportunities, for example, as tenants and/or property owners, or other parties, as described herein, in exchange for completing one or more challenges, for example, over one or more predetermined periods of time.

For example, an exemplary embodiment provides a first party, such as an employer, organization, or business, among other parties to provide awards, such as wealth building rewards or other rewards, to a second party, such as an employee, customer, patron, participant or donor to an organization, such as a charitable organization, among other second parties, in exchange for the second party completing one or more challenges, for example, over one or more predetermined periods of time. In this way, the exemplary embodiments provide a system for and method of incentivizing a second party, such as a tenant, renter, employee, customer, patron, and/or participant in an organization, among other second parties, to complete one or more challenges, actions, tasks, and/or steps over one or more predetermined periods of time in exchange for a first party, such as a property owner, employer, organization, and/or business, among other first parties, to provide one or more awards, such as one or more wealth building rewards, among other rewards.

In an exemplary embodiment, the systems and methods relate to a Wealth Building Rewards (WBR) program for one or more employees and/or one or more employers.

These exemplary embodiments expand on the exemplary embodiments described herein and provide additional features, processes, and/or decision logic for engaging one or more employees, employers, tenants, and/or property owners, or other parties as described herein, in wealth-building activities through one or more rewards, investment opportunities, and/or platform interactions, among other things.

In this way, the exemplary embodiments provide a party with a path to financial success, utilizing an exemplary platform, that builds wealth, strengthens loyalty, and/or incentivizes or elicits one or more actions and/or behaviors and/or other activities from one or more parties.

In some examples, the systems and methods include one or more award types, such as expanded award types. In some examples, the exemplary embodiments include financial incentives, investment stakes, credits, and/or other benefits. In some examples, these award types can be tied to property management and/or engagement, employee management and/or engagement, among other things.

The exemplary embodiments provide or enable enhanced data collection. For example, the system may collect and process a wider variety of data, such as one or more of images, audio, video, and survey responses, among other things, thereby providing more robust property assessments and participant engagement, employee management and/or engagement, among other things.

In some exemplary embodiments, the systems and methods include automated assessment and award determinations. For example, in an embodiment, one or more algorithms, for example including one or more neural networks, are used to assess the completion of one or more challenges, property status, or other things as described herein, and determine one or more awards, such as one or more appropriate rewards.

In some examples, such as a system and method configured for as a tenant and property owner, the exemplary embodiment includes decision logic for escalating issues and/or triggering maintenance.

In some exemplary embodiments, the systems and methods are configured for one or more participant roles, such as one or more different participant types (e.g., tenants, employees, property owners, and/or operators, among other types) and their interactions with the platform.

In some exemplary embodiments, the system and method are configured for one or more awards, such as referral and credit building, including, for example, referral bonuses, credit reporting, and/or financial education modules, among other things. For example, a financial education module includes knowledge and education in one or more of budgeting, debt, and/or investing. In an example, an investing and saving module includes knowledge and education in one or more of investing, such as investment strategies including small and consistent investing. In another example, a credit building module includes knowledge and education in one or more of loan approvals, interest rates, and other things, for example, with potential to unlock future opportunities.

In an example, a renter funding and revenue sharing module includes one or more flexible funding models, including renter-funded rewards and revenue sharing. For example, in an embodiment, the renter pays a first amount (e.g., $10) with a revenue sharing amount (e.g., $5) being shared to an operator.

In other examples, an operator funding and revenue sharing module includes one or more flexible funding models, including operator-funded rewards and revenue sharing. For example, in an embodiment, the operator pays a first amount (e.g., $10) with a rebate (e.g., $5) to the operator.

In another exemplary embodiment, the system includes a portfolio analysis module configured to aggregate data across multiple properties for trend analysis and predictive maintenance.

As an example in exchange for completing one or more challenges, such as changing an air filter on the second party's vehicle, the second party is awarded $100. In another example, a user is provided rewards on REITS platform. In another example, a user is awarded money on a gift card for example a restaurant gift card, or the user is awarded one or more items such as a coffee mug. Other rewards are possible in exchange for a second party completing the one more challenges.

In another example, the platform enables a first party to create an incentivize, one and more activities or behavior and more particularly to create customized incentives for a second party to complete one or more challenges in order to incentivize one or more specific behaviors and/or activities.

The rewards are not limited to instrument or distribution of money, products, objects, or other tangible items. Paper rewards can include one or more opportunities to perform other actions such as purchasing one or more shares on a REITS platform, stock trading platform, vendor platform, retail products, or website websites, services, among other things.

In an example, the wealth building rewards platform provides a mechanism for the first party to encourage certain, desired behavior or incentivize certain, desired behavior or create such behavior by one or more second parties. In another example, the wealth building rewards platform provides a mechanism for a second party to redeem rewards in exchange for behavior that a first party is trying to incentivize or create or encourage.

The rewards that are awarded by the first party to the second party or that can be redeemed by the second party are not limited to any specific award and include one or more awards as described here in.

In other embodiments, the first party and second party are not limited to any particular types, size or arrangement of parties or organizations or companies and can include one or more individuals or groups of individuals.

The exemplary embodiments provider a mechanism for a first party, for example a company or property owner or business or service provider, among other things, to build a customized rewards platform for one or more second parties, such as one or more employees, one or more customers or patrons one more organization, members of one or more organizations, donors, or other things.

In embodiments, the platform can be hosted by a third-party and provide a first party interface and/or a second party interface to facilitate the determination and/or issuance of one or more rewards in exchange for completing one or more challenges.

In an example, a first party can select and/or customize the challenges.

In another example, a second party can select and/or customize awards in the manner in which they are redeemed, applied among other things.

For example, a first party can utilize the first party platform to send out a challenge or one or more challenges to a second party or one or more second parties to complete in particular challenge for example taking a picture and posting the picture within a specific period of time such as taking and posting a picture that day or that evening, in exchange for one or more predetermined rewards. In this way, the first party can incentivize or elicit one or more challenges to be completed by one or more second parties in exchange for one or more awards during one or more predetermined periods of time. In other embodiments each completed challenge can result in a progression of awards, or can be based on additional challenges to be completed by the second party, among other things.

In other examples, the systems and methods can be utilized to expand opportunities to employers and/or employees in a manner similar to tenants and property owners.

The exemplary systems can provide wealth building rewards such as investment opportunities, as well as other types of rewards such as financial education opportunities to invest in, save, bank or other checking, savings, or money market accounts, access to credit monitoring services and other services, among various other things.

In an example, the system and method can provide one or more awards upfront, that is, at the time of signing up, in exchange for completion of one or more challenges. For example, the system and method can include a criteria, set of steps, and/or challenges to be completed over a period of time, for example, such as a first year, following sign up and awards, and can be triggered by completion of one or more steps during the predetermined time.

In another example, one or more awards can be triggered based on completion of one or more forms, questionnaires, and/or surveys. The completion of the one or more challenges or steps can be tied to one or more awards and/or further tied to one or more applications or uses of the one or more awards in order to further incentivize additional activities, behaviors, and/or steps by the second party.

In an example, a second party completes a 3 to 4 question survey that is tied to a $100 reward that is only investible, or permitted to be invested, into one or more predetermined funds or investments. In this way, the second party is incentivized to complete the survey in exchange for an award, and is further incentivized to invest the award in one or more predetermined uses such as one or more predetermined investment funds or accounts. As a result, the exemplary systems and methods cannot only incentivize an initial behavior by one or more second parties based on the completion of one or more challenges, but the exemplary systems and methods also can incentivize additional behaviors by controlling and/or customizing additional options and/or opportunities available to the second party after those challenges have been completed based on the completion of one or more additional challenges.

In another example, the systems and methods can be provided to one or more of (a) a property owner, (b) an employer, (c) an employee, or other first and our second party as described in the examples herein, in exchange for a predetermined fee such as a monthly subscription fee, for example, $10 per month. Such a fee can be collected as part of a subscription as a service (SaaS) platform.

In another example, one or more first parties can incentivize one or more second parties to complete one or more challenges by providing a referral award, for example, to a friend or other referral along with an award to the second party.

For example, in exchange for referring a friend to the platform a second party is provided a $75 award that can be used for example for predetermined investment opportunities and a friend or referral is provided a $25 award that can be used for a similar investment opportunity or another opportunity or use. In examples, the award for the second party and a third-party referral, such as a friend can be the same amounts or different amounts or can be of a different type of an award or each of the parties can select a preferred type of award. And some examples, the award or use of the award can be the same for each party for example use of the award and an investment opportunity or account or in other examples the award or use of the award Kim be different for the parties.

In other examples, the first party, such as a property owner, company, or other party can customize and/or add one or more additional or customized rewards to the platform based on their desired actions and/or behaviors to be incentivized by second parties associated with their industry, products, and/or services, or other things.

In another example, an exemplary embodiment is directed to a platform that helps parties, such as renters, employees, etc., build wealth through real estate investments, financial education, and/or credit building. The platform offers a rewards system where the parties can earn up to $200 in investable funds by completing certain tasks within their first year, for example of renting, employment, etc. In an exemplary embodiment, the system is customizable for property owners and employers, who can provide additional rewards and surveys to gather insights from renters or employees. In an example, the platform charges a $10 monthly fee, with a portion of this fee providing revenue and a portion of the rewards being investible or permitted to be invested.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 illustrates an exemplary system framework according to exemplary embodiments of the invention.

FIG. 2 illustrates an exemplary system according to exemplary embodiments of the invention.

FIG. 3 illustrates an exemplary computing system according to exemplary embodiments of the invention.

FIG. 4 illustrates an exemplary flow process according to exemplary embodiments of the invention.

FIGS. 5-25 illustrate an exemplary flow process of a user interface of a tenant application and a user interface of a property owner application for a Move-In inspection submission according to exemplary embodiments of the invention.

FIGS. 26-42 illustrate an exemplary flow process of a user interface of a tenant application and a user interface of a property owner application for a periodic inspection submission according to exemplary embodiments of the invention.

FIGS. 43-67 illustrate an exemplary flow process of a user interface of a tenant application and a user interface of a property owner application for a Move-Out inspection submission according to exemplary embodiments of the invention.

FIGS. 68-70 illustrate an exemplary flow process of a user interface of a tenant application for an Awards and Wealth Building process according to exemplary embodiments of the invention.

FIG. 71 illustrates an exemplary tenant/resident lifecycle according to exemplary embodiments of the invention.

FIG. 72 illustrates other exemplary aspects according to exemplary embodiments of the invention.

FIG. 73 illustrates exemplary renter modules according to an exemplary embodiment of the invention.

FIG. 74 illustrates exemplary employee modules according to an exemplary embodiment of the invention.

FIG. 75 illustrates exemplary user dashboards according to an exemplary embodiment of the invention.

FIG. 76 illustrates exemplary awards according to an exemplary embodiment of the invention.

FIG. 77 illustrates a flow process for a renter according to an exemplary embodiment of the invention.

FIG. 78 illustrates a dynamic dashboard for a property owner according to an exemplary embodiment of the invention.

FIG. 79 illustrates a flow process for an employee according to an exemplary embodiment of the invention.

FIG. 80 illustrates a dynamic dashboard for an employer according to an exemplary embodiment of the invention.

FIG. 81 illustrates an investment fund overview according to an exemplary embodiment of the invention.

FIG. 82 illustrates another flow process for an employee according to an exemplary embodiment of the invention.

FIG. 83 illustrates system funding options according to an exemplary embodiment of the invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Exemplary systems for, and methods of, assessing a status of a part of a property occupied by a tenant will now be described.

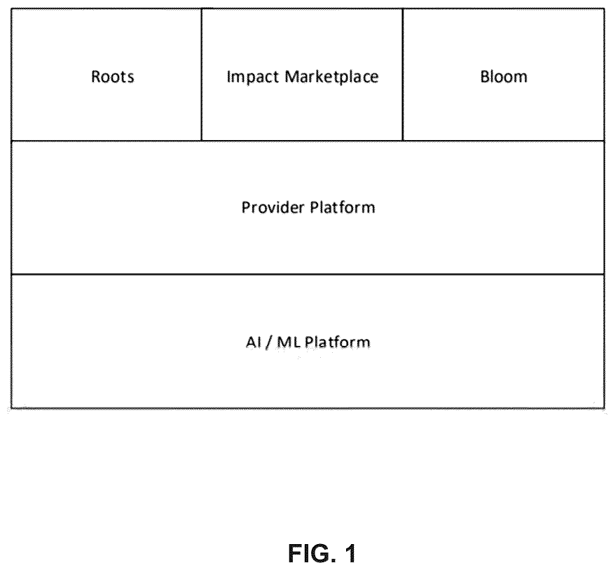

FIG. 1 illustrates an exemplary system framework according to exemplary embodiments of the invention. The framework can include an investment fund platform or application, a platform or application partnering tenants and property owners, and a platform or application for providing impact in the marketplace. The applications can be provided individually or as part of a monolithic application (e.g., web application).

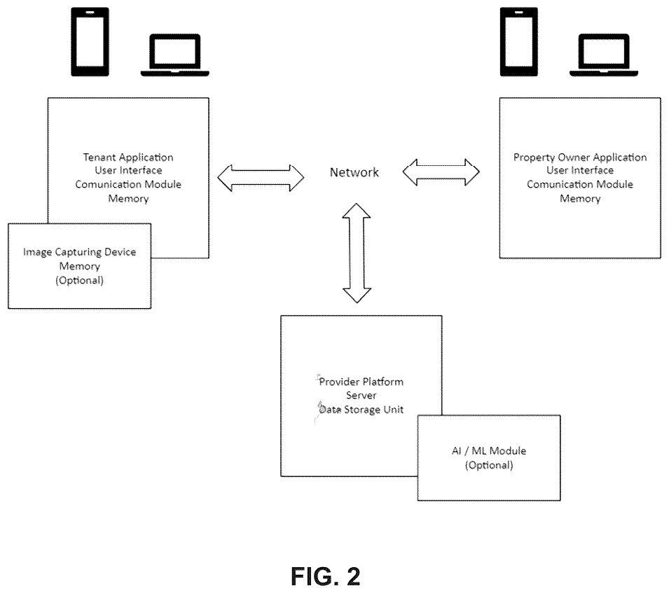

As illustrated in FIGS. 1-3, an exemplary system includes a provider platform (e.g., “provider application programming interface (API),” “provider GUI,” etc.) in communication with one or more tenant applications (e.g., “tenant API,” “tenant GUI,” etc.) and one or more property owner applications (e.g., “property owner API,” “property owner GUI,” etc.). The provider platform can include one more servers in communication with one or more computing devices, the one or more servers including one or more processors and one or more non-transitory computer-readable storage mediums storing one or more instructions comprising one or more algorithms that when executed by the one or more processors cause the one or more processors to perform one or more steps. The one or more servers can include one more communication modules.

The provider platform, tenant application, and/or property owner application can be accessed by a tenant or property owner, respectively, via one or more computing devices, such as a mobile device (e.g., smart phone, smart watch, etc.), laptop, notebook, desktop, and/or other computing device having a user interface and a communication module. The one or more computing devices can include one or more processors and one or more non-transitory computer-readable storage mediums storing one or more instructions comprising one or more algorithms that when executed by the one or more processors cause the one or more processor to perform one or more steps. The one or more computing devices can include one more communication modules.

In an example, the one or more computing devices can include one or more displays configured to display image data.

In an example, the one or more computing devices can include one or more image capturing devices configured to generate image data. The image data can include one or more photos, one or more videos, and/or one or more frames of one or more videos, among other data, including metadata. In an example, the one or more computing devices can include one or more audio capturing devices (e.g., microphone) configured to generate audio data and/or generate text, for example, from spoken words.

In some examples, computing technology (e.g., cloud-based computing technology) can run one or more machine learning algorithms with inputs of the one or more tenant submissions (e.g., image data including one or more still images, one or more video images, and/or one or more frames of one or more video images) to determine a condition of one or more items associated with a property, for example, one or more items associated with a region, area (e.g., interior or exterior), room, fixture, furniture (e.g., furniture provided by the property owner for the use of the tenant during the term), door, appliance, structure, mechanical/electrical system, or other part of the property, or one or more portions, parts, or components thereof of the property, among other things. The server or the provider platform may be configured to execute one or more artificial intelligence algorithms, and more particularly, one or more machine learning models, to assess a condition or status of the item in the image data received from the tenant. The one or more machine learning models can include, for example, one or more neural networks, such as transformer neural networks, NVIDIA DeepStream technology, etc. The one or more neural networks are not limited to any particular neural networks and can include one or more neural networks, such as transformer neural networks, and/or other technology for analyzing one or more of collected image data (e.g., video image data, frames of video image data, etc.), audio data (e.g., captured audio recordings of spoken words), textual data (e.g., sequential text), etc. and/or one or more datasets including such data.

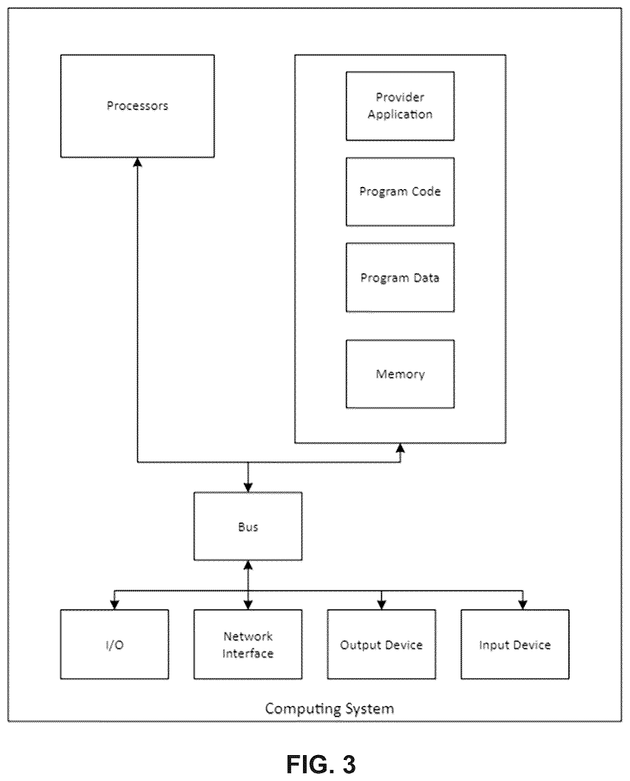

FIG. 3 illustrates an exemplary process flow according to the embodiments of the invention.

In an example on-boarding process, the provider platform can initiate sending an invitation and/or a message to the tenant, without a request from the tenant, via a tenant application, text message, email, instant messaging, and/or other in-app messaging, etc. In an example, the invitation can include a link for the tenant to register and/or create a new system identification (e.g., system ID). In another example, the invitation can include information on how to access a link or portal for registering and/or creating a new system ID.

Upon receipt of the invitation, the tenant can follow the instructions or link to access a portal to register and/or create a new system ID. The new system ID of the tenant can be associated by the provider platform with the property owner.

In another example, a tenant can request a new system identification (e.g., system ID) associated with a particular property owner from the provider platform using a tenant application. In an example, the tenant can search a database of one or more property owners using the tenant application to identify the property owner.

In response to the tenant request, the provider platform can send an invitation and/or a message to the tenant via the tenant application, text message, email, instant messaging, and/or other in-app messaging, etc. The invitation can include a link for registering and/or creating a new system ID or information on how to access a link for registering and/or creating a new system ID. In some examples, the invitation can include a link for generating a lease or rental agreement and/or an addendum to a lease or rental agreement covering the terms of one or more of the systems according to the present invention.

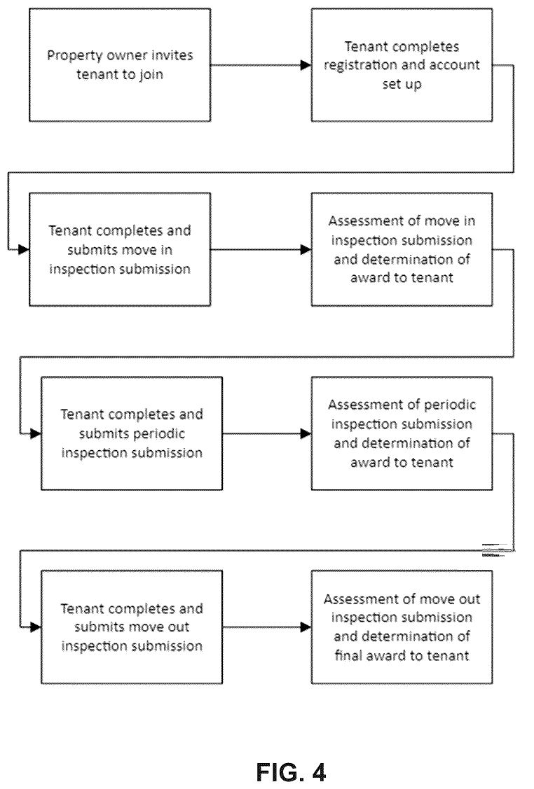

With reference again to FIG. 4, at Move-In, a tenant completes a Move-In inspection submission. The Move-In inspection submission is then assessed and a determination and/or calculation of an award to the tenant can be performed. Next, a tenant completes one or more periodic inspection submissions. The one or more periodic inspection submissions are then assessed and a determination and/or calculation of an award to the tenant can be performed. At Move-Out, a tenant completes a Move-Out inspection submission. The Move-Out inspection submission is then assessed and a determination and/or calculation of an award (e.g., a final award) to the tenant can be performed.

### EXAMPLE 1

### Move-In Inspection

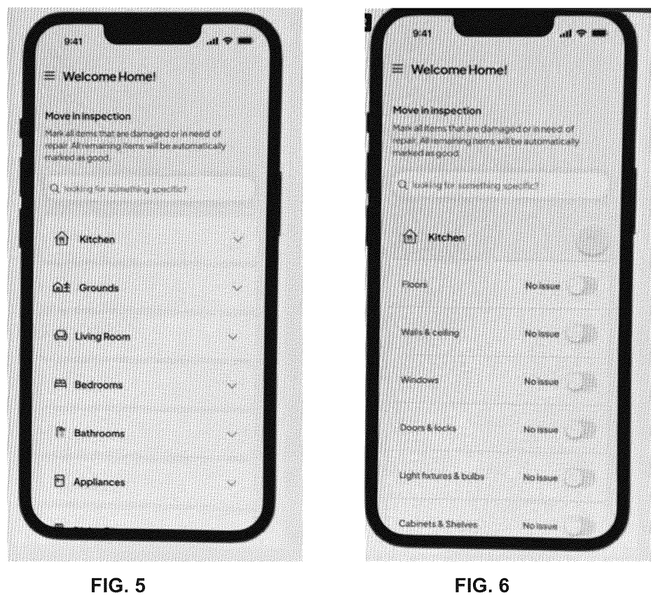

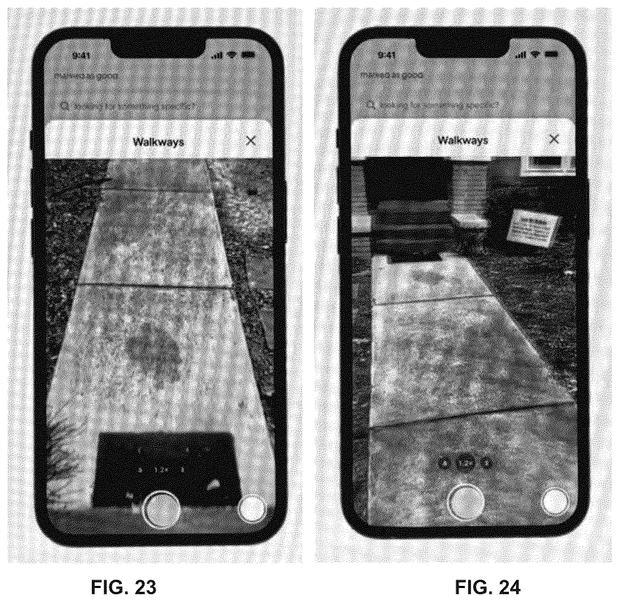

With reference to FIGS. 5-24, an example Move-In process for completing a Move-In inspection submission will now be described with reference to an example of a graphical user interface of a tenant application (tenant GUI).

Following the on-boarding process, at Move-In, the provider platform can send an invitation and/or a message to the tenant, without a request from the tenant, via a tenant application, text message, email, instant messaging, and/or other in-app messaging, etc. In an example, the invitation can include a link for the tenant to complete a Move-In inspection. In another example, the invitation can include information on how to access a link or portal for completing the Move-In inspection. Upon receipt of the invitation, the tenant can follow the instructions or link to access the tenant application and complete the Move-In inspection. The property owner application can enable the property owner to use standard invitations and/or messaging or enter custom messaging, for example, based on the particular tenant and/or the particular property.

As shown in FIGS. 5-24, the tenant GUI displays a Move-In inspection questionnaire for a tenant application. The tenant application can ask the tenant to notify or identify to the property owner a status of one or more items associated with the property, such as any items that are damaged or in need of repair, a condition of any items, etc. In an example, the tenant application provides a pre-populated list of items associated with the property for selection by the tenant. However, in other examples, the tenant application can permit the tenant to enter items to be listed or added to a pre-populated list, or to select items to be listed from a template or sample list of items.

Referring to FIG. 5, in this example, the tenant application asks the tenant to mark all items that are damaged or in need of repair. The tenant application notes that all other items will be automatically marked as good. In other examples, the tenant application can require the tenant to mark some or all of the additional items. For example, the tenant can be required to affirmatively note or acknowledge the status of each of the listed items. In an example, the provider platform can enable the property owner to populate or identify the items included in the list, to select whether unanswered items are automatically marked or whether some or all of the items must be marked by the tenant, along with other criteria such as information displayed, questions asked, etc.

Referring again to the example illustrated in FIG. 5, the tenant application can display a list of items associated with the property (e.g., one or more categories, locations, and/or parts, etc. of the property) including, for example:
Kitchen
Grounds
Living Room
Bedrooms
Bathrooms
Appliances

The list is not limited to any particular categories, locations, and/or parts, etc. of the property, and can include other items such as mechanical/electrical equipment, utilities, roof, siding, plumbing, electrical, data, phone, etc. The tenant can select an item from the list using, for example, a toggle or other selection feature of the tenant application as shown in FIG. 6. In an example, the tenant application can include a search window to search for a particular item.

Referring again to the example illustrated in FIG. 6, in response to the tenant selecting an item (e.g., a primary item/first tier item/first level item, in this case “Kitchen”) from the list, the tenant application displays another list of items (e.g., secondary items/second tier items/second level items/sub-categories) associated with the selected primary item including, for example:
Floors
Walls and Ceilings
Windows
Doors and Locks
Light Fixtures and Bulbs
Cabinets and Shelves

The list is not limited to any particular sub-categories, locations, and/or parts, etc. of the property, and can include other items such as furnishings (e.g., kitchen table, chairs, stools, etc.) among other things.

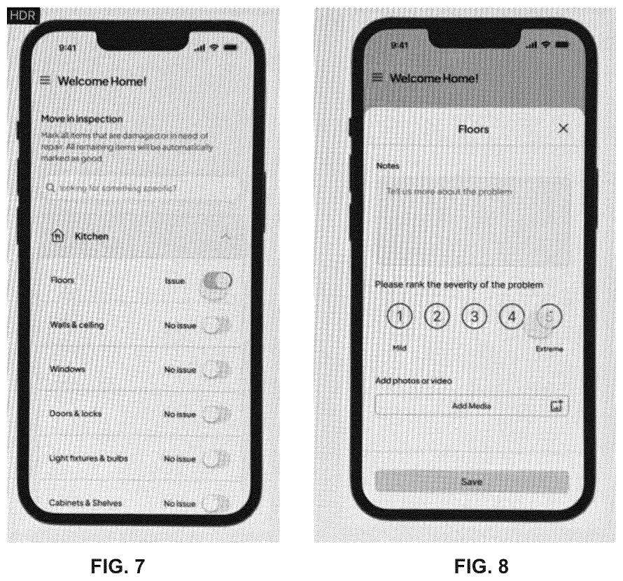

The tenant can select an item from the list using, for example, a toggle or other selection feature of the tenant application. In this example, the toggles default to “No Issue. ” If the tenant has identified an issue with an item, then the tenant can select the toggle to mark the item as having an “Issue,” as shown in FIG. 7. In an example, the tenant application can include a search window to search for a particular item. The list is not limited to any number of sub-lists, tiers, levels, etc. In another example, in response to the tenant selecting a second-tier item, such as “Floors,” the tenant application can further display a list of one or more tertiary items/third tier items/third level items, such as wood, carpet, tile, PVC, laminate, and/or concrete, etc.

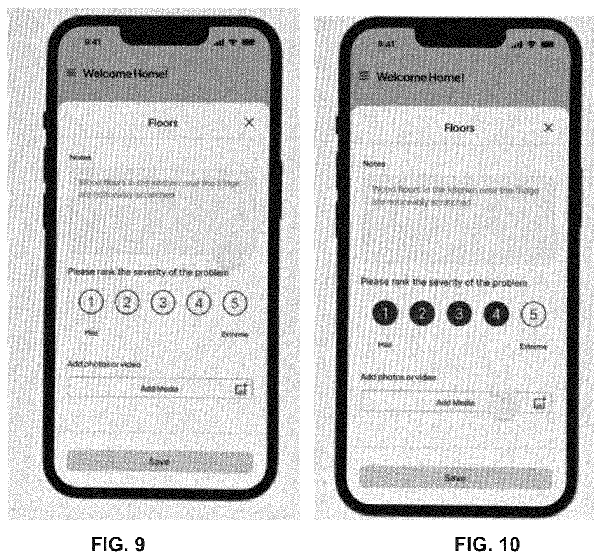

Referring to the example illustrated in FIG. 8, in response to the tenant selecting a secondary tier item (or in other examples, in response to the tenant selecting an item from another tier, such as a tertiary tier), the tenant application optionally displays an input screen enabling the tenant to provide information to the property owner regarding the specific item selected. For example, the tenant application can display a “Note” section enabling the tenant to provide comments, description, or other text about the identified problem. For example, in the example illustrated in FIG. 9, the tenant can input a comment indicating that “wood floors in the kitchen near the fridge are noticeably scratched.” The tenant application can display a “Save” feature enabling the tenant to save comments, description, or other text about the identified problem before moving on to another step. In other examples, the tenant application can be configured to automatically save any entries or selections in response to each entry.

In an example, the tenant application optionally can display a ranking feature enabling the tenant to rank a severity of the identified problem, such as a ranking of 1-5, where 1 is a mild problem and 5 is an extreme problem. One of ordinary skill will recognize that other rankings features or mechanisms can be provided, such as text only, a slide (e.g., vertical or horizontal) indicating severity, etc. As shown in the example illustrated in FIG. 10, the tenant has selected a severity of 4 out of 5. The tenant application can display a “Save” feature enabling the tenant to save the severity ranking about the identified problem before moving on to another step. In other examples, the tenant application can be configured to automatically save any entries or selections in response to each entry.

Referring to the example illustrated in FIG. 10, the tenant application can display a feature enabling the tenant to upload media to be submitted by the tenant to the property owner (i.e., a tenant submission), and particularly, image data including one or more of photo and/or video (e.g., video with or without audio data).

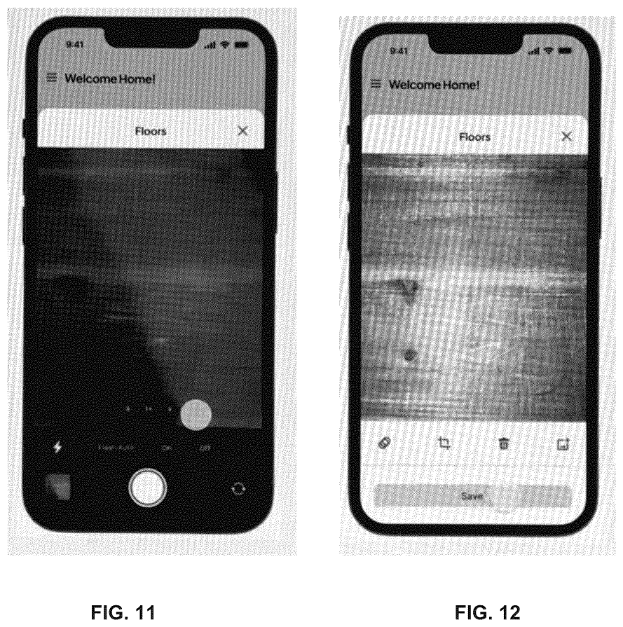

As shown in FIG. 11, the tenant application can access an image capturing device of the computing device, such as the camera of a smartphone, to capture one or more photos and/or one or more videos of the item, in this example, wood floors. In other examples, such as when the tenant application is accessed using a computing device that is not portable and/or does not have an image capturing device, the tenant application can enable an image file to be selected from a memory device.

As shown in FIG. 12, in response to capturing image data of the item, the tenant application can display one or more features (e.g., functional icons) for editing the image data, such as cropping the displayed version of the image data, deleting the image data, and/or saving the image data, among other image data editing features.

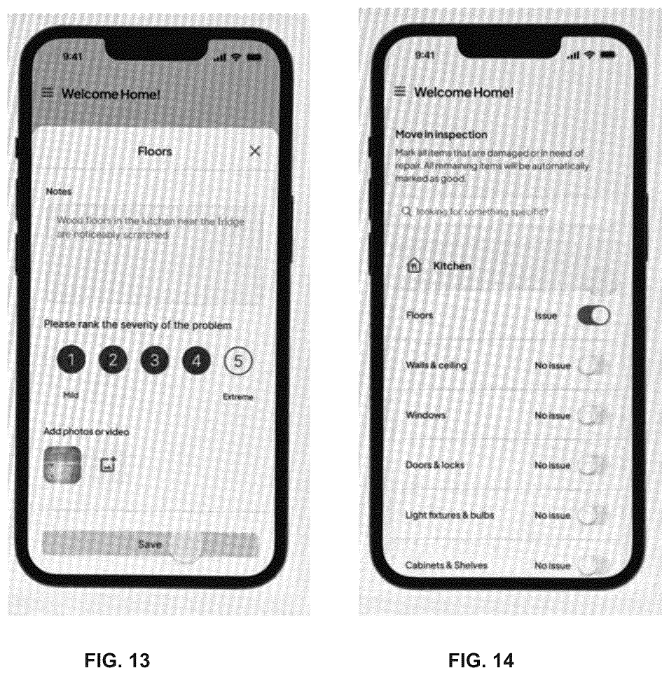

As shown in FIG. 13, in response to saving the image data, the tenant application can display one or more features (e.g., functional icons) for adding additional image data. Also, in response to saving the image data, the tenant application can display a “Save” feature enabling the tenant to save the entries for that particular item, such as the comments, description, or other text about the identified problem, the severity ranking about the identified problem, and/or the uploaded image data.

As shown in FIG. 14, in response to saving the entries for that particular item (in this example, the status of the floor in the kitchen), the tenant application can return to the list of kitchen items. If the tenant wishes to enter information on any other items associated with the kitchen, the tenant can follow the same or similar steps to enter information regarding those items.

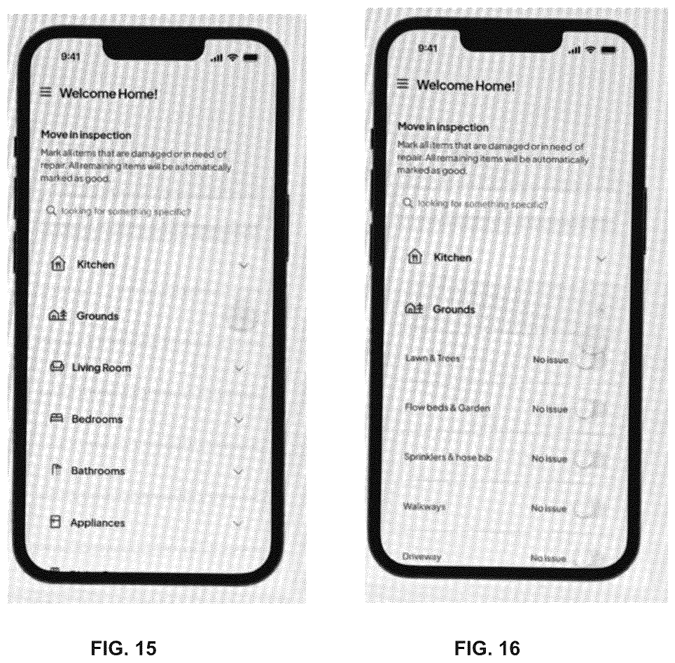

If the tenant does not have additional information to enter on any other items associated with the kitchen, then the tenant application can return to the list of first tier items associated with the property, as shown in FIG. 15. The tenant can select another item from the list using, for example, a toggle or other selection feature of the tenant application, in this example, “Grounds.”

As shown in FIG. 16, in response to this selection, the tenant application displays another list of items (e.g., secondary items/second tier items/second level items/sub-categories) associated with the selected primary item (i.e., Grounds) including, for example:
Lawn and Trees
Flower Beds and Garden
Sprinklers and Hose Bib
Walkways
Driveway

The list is not limited to any particular sub-categories, locations, and/or parts, etc. of the property, and can include other items such as pool, patio, deck, shed, garage, fence, playground equipment, storage, pergola, among other things. The tenant can select an item from the list using, for example, a toggle or other selection feature of the tenant application. In this example, the toggles default to “No Issue.”

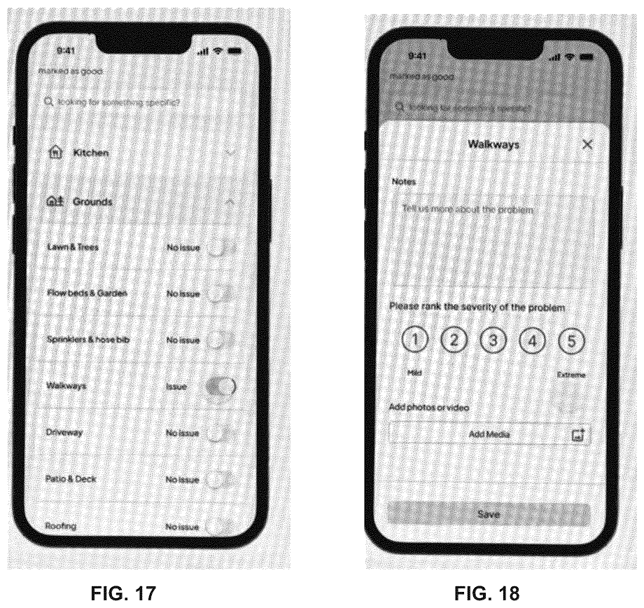

If the tenant has identified an issue with an item, then the tenant can select the toggle to mark the item (in this example, Walkway) as having an “Issue,” as shown in FIG. 17.

In another example, in response to the tenant selecting a second-tier item, the tenant application can further display a list of one or more tertiary items/third tier items/third level items. For example, in response to the tenant selecting “Walkways,” the tenant application can further display a list of one or more tertiary items such as Front, Rear, Side, North, South, East, and/or West Walkway, etc. Similarly, in other examples, in response to the tenant selecting “Lawn and Tress,” the tenant application can further display a list of one or more tertiary items such as Front, Rear/Back, and/or Side Yard, etc. The tier items (e.g., first, second, and/or third tier items) are not limited to any particular example.

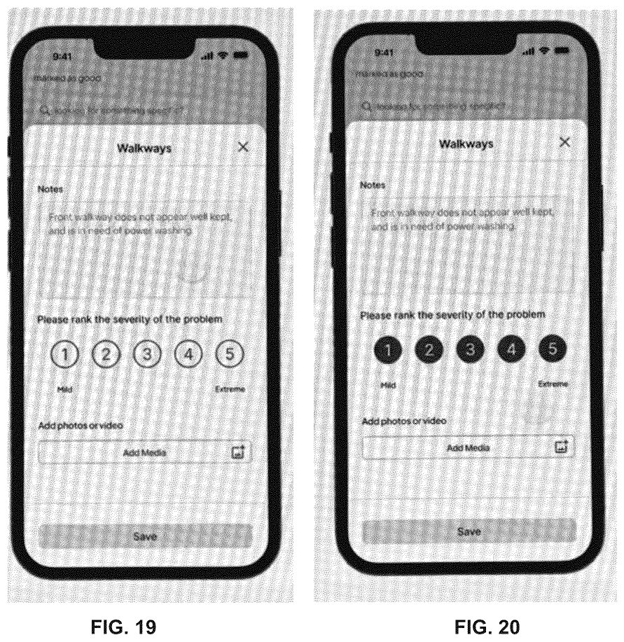

Referring to the example illustrated in FIG. 18, as with the example above, in response to the tenant selecting a secondary tier item (or in other examples, in response to the tenant selecting an item from another tier, such as a tertiary tier), the tenant application optionally displays an input screen enabling the tenant to provide information to the property owner regarding the specific item selected, in this example the Walkways. The tenant application optionally can display a “Note” section enabling the tenant to provide comments, description, or other text about the Walkways. For example, in the example illustrated in FIG. 19, the tenant input a comment indicating that “front walkway does not appear well kept and, and is in need of power washing.”

In an example, the tenant application can access an audio capturing device of the computing device, such as the microphone of a smartphone, to record an audio comment (e.g., captured audio recordings of spoken words). The provider application can be configured to analyze the collected audio data using, for example, one or more machine learning processes, such as one or more neural networks, such as transformer neural networks, one or more Large Language Models (LLM's), etc. The provider application (e.g., API) can be configured to receive text and/or audio data from the tenant application and generate text responses or prompts (e.g., within text boxes and/or chat windows) based on inputted audio data and/or other data which can be integrated into the functionality of the graphic user interface of the tenant application.

In this example, the tenant application optionally can display a ranking feature enabling the tenant to rank a severity of the Walkways, such as a ranking of 1-5, where 1 is a mild problem and 5 is an extreme problem. As shown in the example illustrated in FIG. 20, the tenant has selected a severity of 5 out of 5.

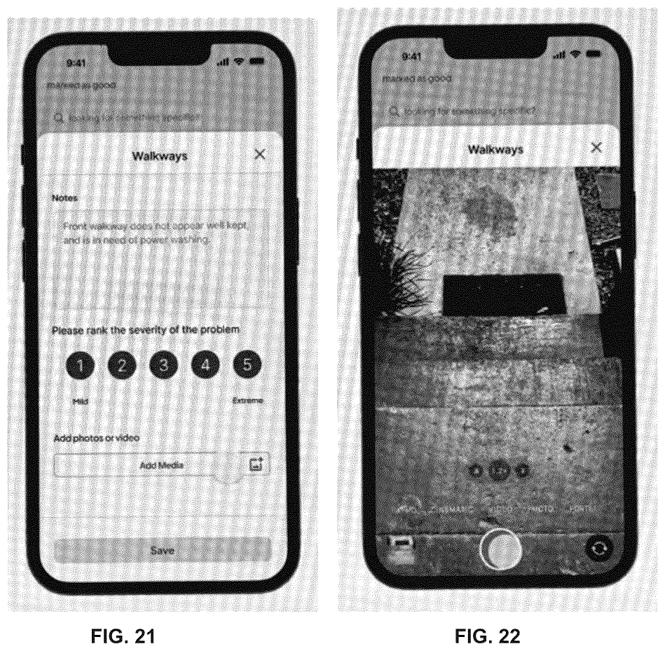

Referring to the example illustrated in FIG. 21, the tenant application can display a feature enabling the tenant to upload media to be submitted by the tenant to the property owner, and particularly, image data of the Walkway, including one or more of photo and/or video (e.g., video with or without audio data).

As shown in FIG. 22, the tenant application can access an image capturing device of the computing device, such as the camera of a smartphone, to capture one or more photos and/or one or more videos of the item, in this example, a video of the Walkways. In other examples, such as when the tenant application is accessed using a computing device that is not portable and/or does not have an image capturing device, the tenant application can enable an image file to be selected from a memory device.

As shown in FIGS. 22-24, the tenant can walk along the Walkways of the property and capture image data (e.g., video) of the Walkways.

In response to capturing image data of the Walkways, the tenant application can display one or more features (e.g., functional icons) for editing the image data. Additionally, the tenant application can display one or more features (e.g., functional icons) for adding additional image data. In response to saving the image data, the tenant application can display a “Save” feature enabling the tenant to save the entries for that particular item, such as the comments, description, or other text about the identified problem, the severity ranking about the identified problem, and/or the uploaded image data. In response to saving the entries for that particular item (in this example, the status of the Walkways), then the tenant application can return to the list of first tier items.

When the tenant has completed entering all entries for Move-In Inspection for the property, the tenant application can prompt the user to complete and submit the tenant submission for the Move-In Inspection to the provider application. In some examples, the tenant application can provide the tenant with an option of reviewing, editing, and/or deleting, etc. the tenant submission before submitting the Move-In Inspection to the provider application.

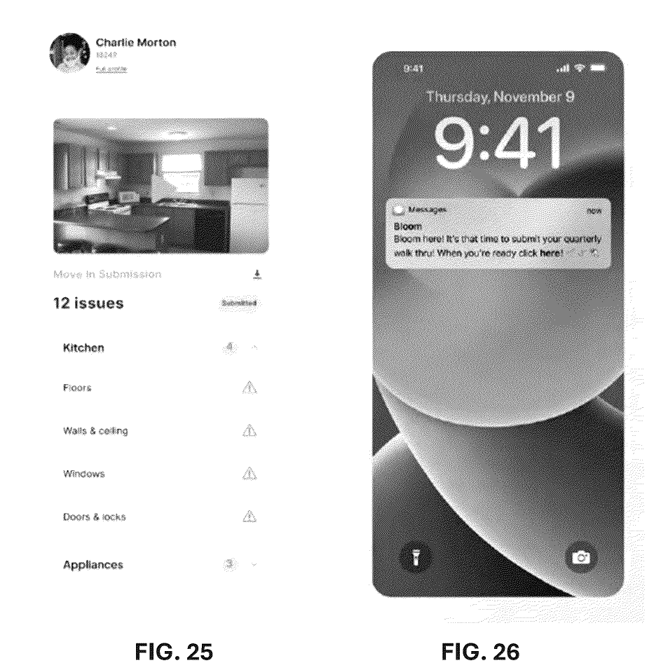

When the tenant submission for the Move-In inspection has been received by the provider platform, the provider platform can provide the tenant submission to the property owner via the property owner application for assessment by the property owner. For example, the provider platform can create a property manager facing Move-In checklist and baseline video. As shown in FIG. 25, the property owner application includes a graphic user interface that displays the contents and attachments of the Move-In Submission. The property owner GUI also can provide additional information or analysis provided by the provider system, such as the property manager facing Move-In checklist, baseline video, and/or an identification of the issues in the Move-In Submission, among other things. In some examples, the provider platform can be configured to provide the tenant submission one or more interested parties or stakeholders, such as property managers.

In another example, the provider platform can assess the tenant submission and provide assessment data to the property owner via the property owner application and/or a determination of one or more awards to be provided or attributed to the tenant. In an example, the provider platform can assess the image data of the tenant submission using, for example, one or more machine learning processes (e.g., neural networks), and provide assessment data to the property owner via the property owner application. Examples of the assessment of the tenant submission and/or determination of one or more awards to the tenant and provision of such assessment data and/or determination being provided to the property owner will be described in more detail below.

### EXAMPLE 2

### Periodic Inspection

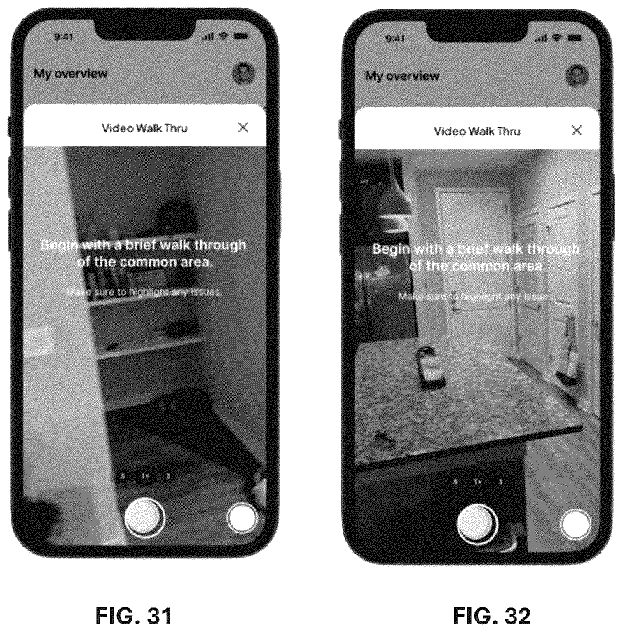

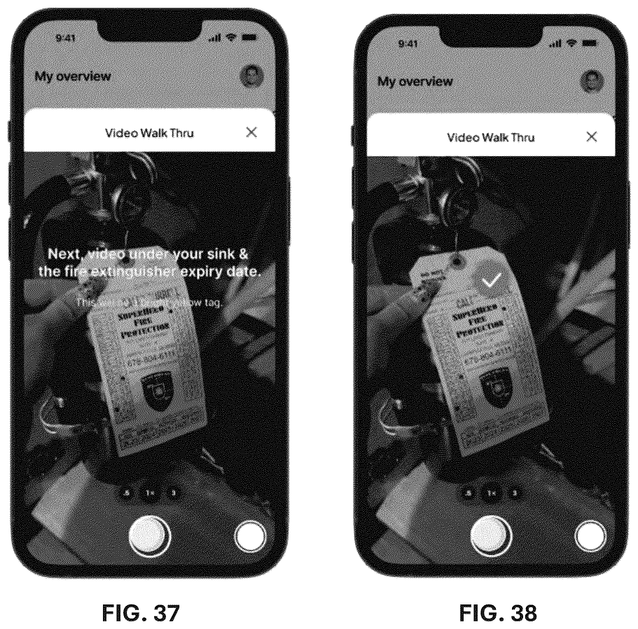

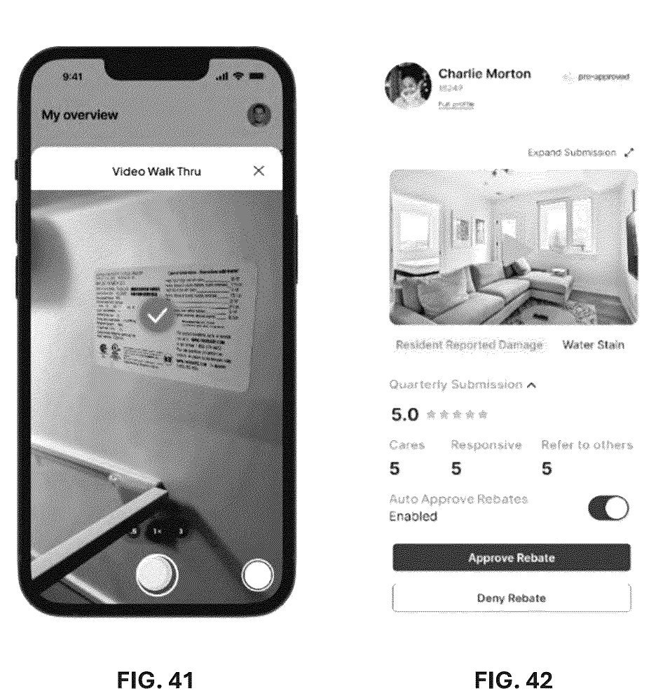

With reference to FIGS. 26-42, an example of a periodic inspection process will now be described.

In exemplary embodiment, a tenant can be requested by the provider platform to perform one or more tenant walk-throughs at one or more times throughout the occupied period. For example, the one or more periodic inspections can include a Move-In Inspection (as described with reference to FIGS. 5-24), monthly inspections, quarterly inspections, annual inspections, on demand inspections (e.g., upon request from a property owner submitted to the provider platform), voluntary inspections (e.g., as determined by and voluntarily initiated and submitted by the tenant), and/or a Move-Out Inspection, among others. In some examples, a quarterly Walk-through for a tenant application performed during the occupied period of the property following Move-In and prior to Move-Out can be similar to, or the same as, the Move-In inspection.

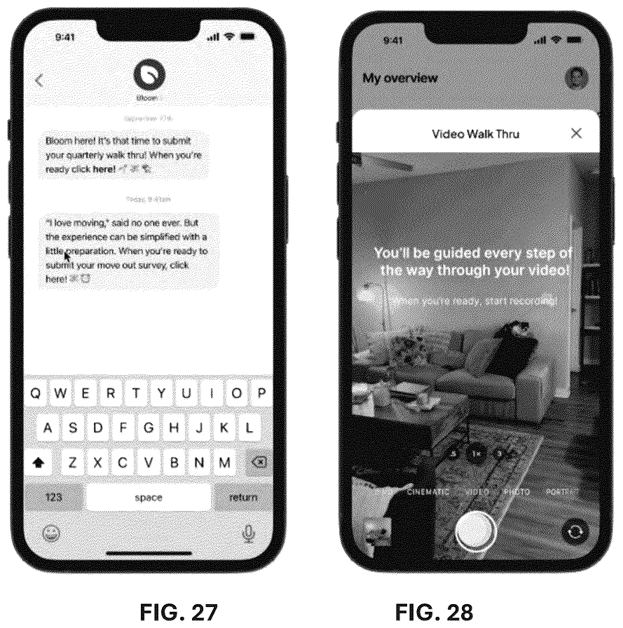

As shown in FIGS. 26 and 27, the provider platform can send an invitation and/or a message to the tenant, without a request from the tenant, via a tenant application, text message, email, instant messaging, and/or other in-app messaging, etc. The property owner application can enable the property owner to use standard invitations and/or messaging or enter custom messaging, for example, based on the particular tenant and/or the particular property. In an example, the invitation can include a link for the tenant to complete a periodic inspection. In this example, the invitation notes that it is time for the tenant to submit a quarterly walkthrough and provides a link to begin the tenant submission.

In some examples, the provider platform can send one or more reminders to the tenant prior to a deadline for completing an inspection (e.g., 30 days prior to a quarterly inspection deadline).

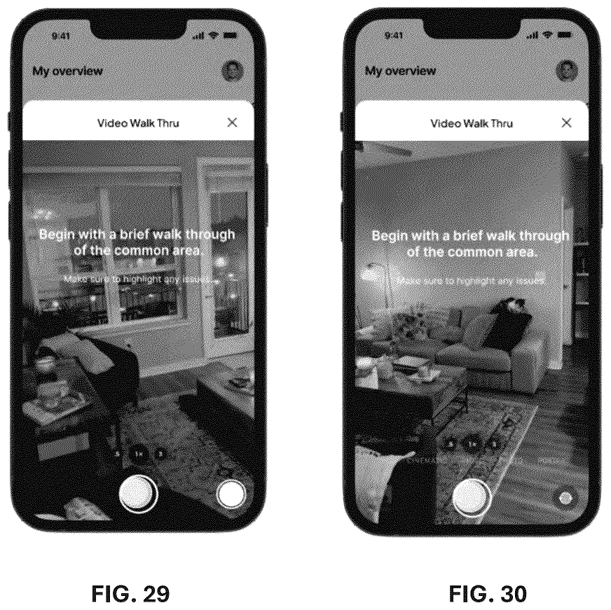

In the example shown in FIG. 28, the graphic user interface of the tenant application prompts and guides the tenant to begin a video walk-through and start recording using the tenant's smart phone. In FIG. 29, the tenant application prompts the tenant to begin with a brief walk-through of the common area and asks the tenant to notify or identify any issues. FIGS. 30-32 show screen shots of the tenant capturing the video walkthrough as the tenant moves about the common area.

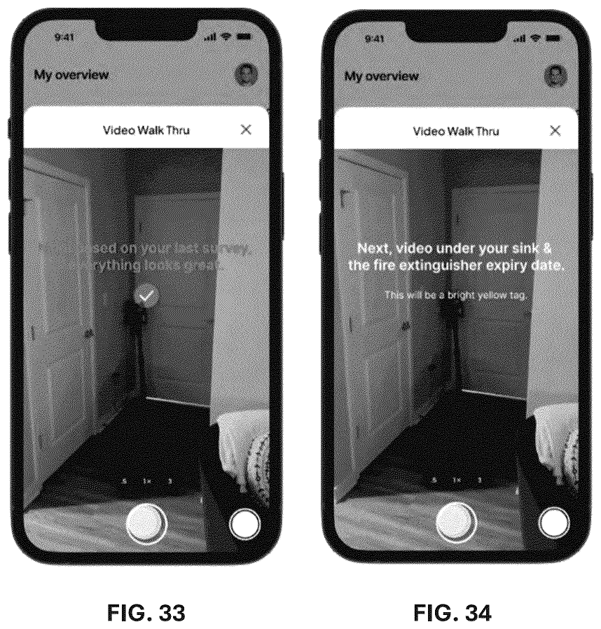

In this example, the provider platform can assess the image data captured by the tenant and/or compare the image data captured by the tenant to stored image data captured in a prior submission or walk-through, such as a Move-In walk-through or a prior periodic walk-through, using, for example, one or more machine learning processes, such as one or more neural networks, such as transformer neural networks, NVIDIA DeepStream technology, etc. In FIG. 33, the tenant application notifies the tenant that everything looks good based on the last survey. prompts the tenant to begin with a brief walk-through of the common area and asks the tenant to notify or identify any issues.

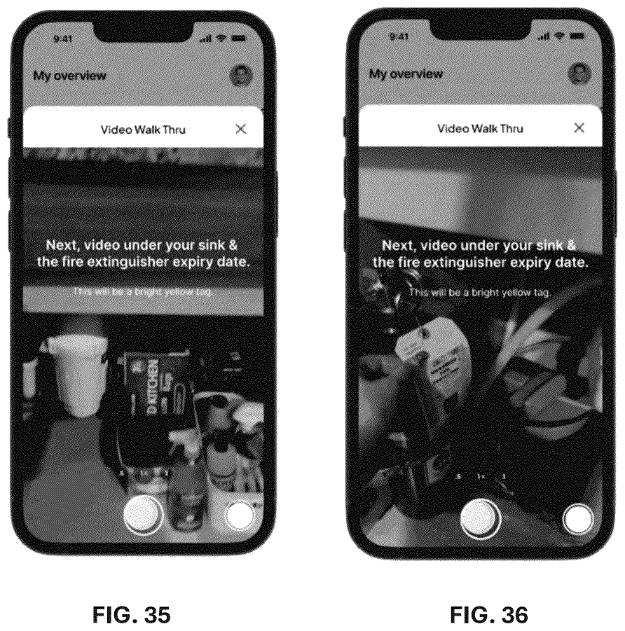

Next, in FIG. 34, the tenant application prompts the tenant to capture video under the sink and the fire extinguisher expiry date. The tenant application provides guidance to the tenant by notifying the tenant that the fire extinguisher expiry date will be a bright yellow tag. In FIGS. 35-38, the tenant captures video under the sink and of the fire extinguisher expiry date on the yellow tag. In this example, the provider platform assesses the image data captured by the tenant using, for example, one or more machine learning processes, such as one or more neural networks, such as transformer neural networks, NVIDIA DeepStream technology, etc., and displays a check mark to the tenant confirming that the fire extinguisher expiry date has been captured and saved.

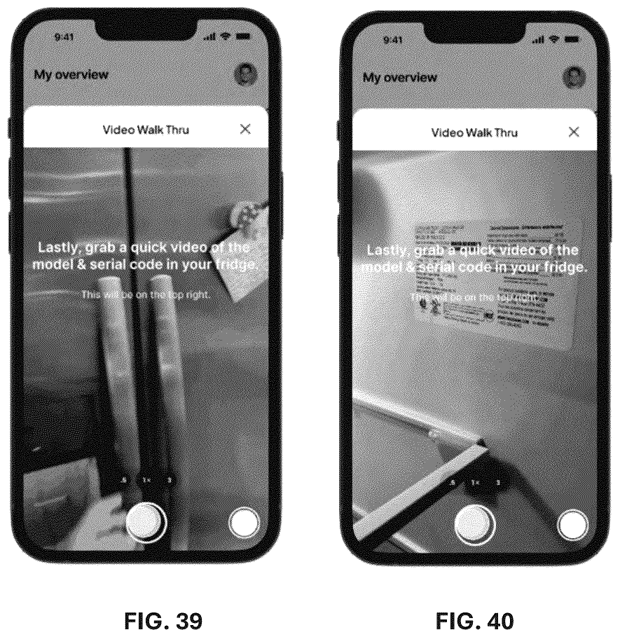

Next, in FIG. 39, the tenant application prompts the tenant to capture video of the model and serial number of the refrigerator. In FIG. 40, the tenant application provides guidance to the tenant by notifying the tenant of the location of the model and serial number in the appliance. In this example, the provider platform assesses the image data captured by the tenant using, for example, one or more machine learning processes, such as one or more neural networks, such as transformer neural networks, NVIDIA DeepStream technology, etc., and displays a check mark to the tenant confirming that the model and serial number of the refrigerator has been captured and saved.

One of ordinary skill will recognize that the tenant application is not limited to the illustrated examples and can be configured to prompt the tenant to capture video and then the provider application can be configured to analyze the video of other items in the property, such as one or more other kitchen appliances, laundry appliances, or other appliances, inspection tags, circuit panels, utilities, lighting and/or plumbing fixtures, carpets, flooring, walls, doors and/or locks, etc. One of ordinary skill also will recognize that the provider application is not limited to the illustrated examples and can be configured to analyze the collected image data using, for example, one or more machine learning processes, such as one or more neural networks, such as transformer neural networks, NVIDIA DeepStream technology, etc. In some examples, the provider application can be configured to analyze and compare the image data to previously captured and stored data for the property, or part of the property, using, for example, one or more machine learning processes, such as one or more neural networks, such as transformer neural networks, NVIDIA DeepStream technology, etc. In other examples, the provider application can be configured to analyze and compare the collected image data to image data in one or more datasets stored in one or more databases using, for example, one or more machine learning processes, such as one or more neural networks, NVIDIA DeepStream technology, etc.

The provider application can be configured to analyze the captured image data, for example, to identify issues based on a comparison with image data stored in a database, predict issues that may need attention based on trained models, etc., identify changes in a state of an item or area from previous image data, among other things.

Similar to the Move-in inspection, the graphic user interface of the tenant application prompts and guides the tenant through the video walk-through and asks the tenant to notify or identify any issues, capture and/or upload image data, such as photos and/or video, and provide comments and/or descriptions, among other things. In an example, the tenant application can access an audio capturing device of the computing device, such as the microphone of a smartphone, to record an audio comment (e.g., captured audio recordings of spoken words). The provider application can be configured to analyze the collected audio data using, for example, one or more machine learning processes, such as one or more neural networks, such as transformer neural networks, one or more Large Language Models (LLM's), etc. The provider application (e.g., API) can be configured to receive text and/or audio data from the tenant application and generate text responses or prompts (e.g., within text boxes and/or chat windows) based on inputted audio data and/or other data which can be integrated into the functionality of the graphic user interface of the tenant application.

For example, the tenant may notify the property owner of an issue, such as a maintenance request that has not been responded to or completed, using the comments by inputting text or using the microphone of the computing device to input audio data. The provider application can be configured to analyze the collected audio data from the tenant application and generate text responses or prompts (e.g., within text boxes and/or chat windows) via the graphic user interface of the tenant application to guide the tenant, prompt the tenant for more information, etc.

When the tenant walk-through had been completed, the provider platform can provide the tenant submission to the property owner via the property owner application for assessment by the property owner. For example, the provider platform can create a property manager facing Quarterly Submission. As shown in FIG. 42, the property owner application includes a graphic user interface that displays the contents and attachments of the Quarterly Submission. The property owner GUI also can provide additional information or analysis provided by the provider system, such as an identification of the issues in the Quarterly Submission, among other things. In some examples, the provider platform can be configured to provide the Quarterly Submission to one or more interested parties or stakeholders, such as property managers.

In another example, the provider platform can assess the tenant submission and provide assessment data to the property owner via the property owner application and/or a determination of one or more awards to be provided or attributed to the tenant, such as a Rebate, as shown in FIG. 42. The property owner application can be configured to enable a property owner to approve or deny a rebate, auto approve rebates, etc. In other examples, the provider platform can assess the image data of the tenant submission using, for example, one or more machine learning processes, and provide assessment data to the property owner via the property owner application. Examples of the assessment of the tenant submission and/or determination of one or more awards to the tenant and provision of such assessment data and/or determination being provided to the property owner will be described in more detail below.

### EXAMPLE 3

### Move-Out Inspection

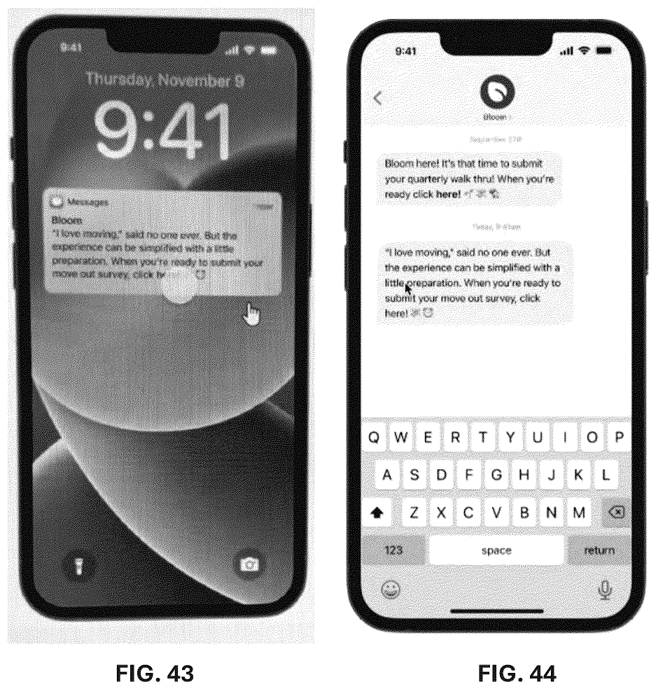

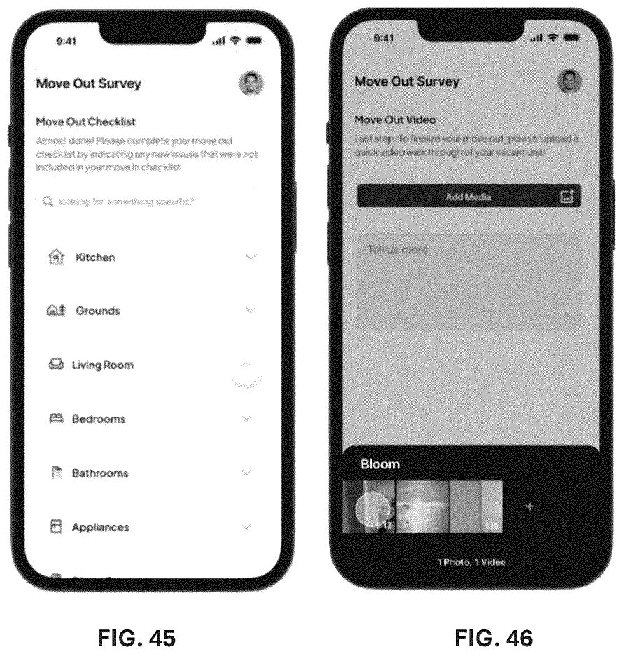

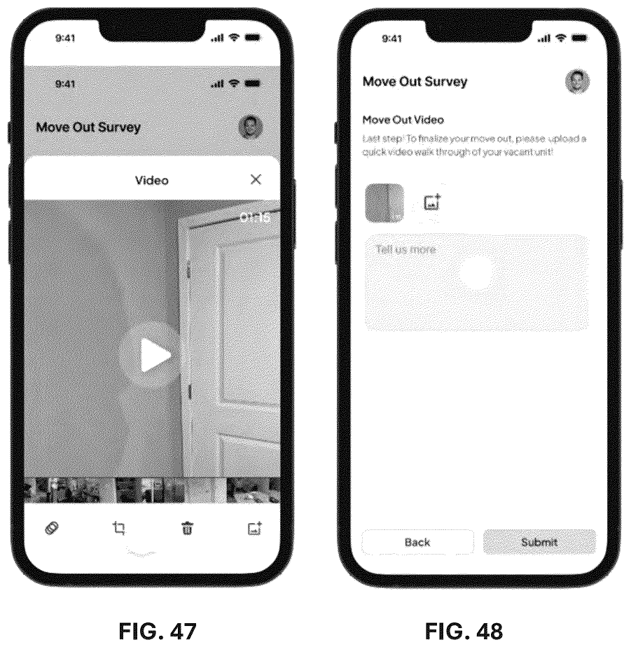

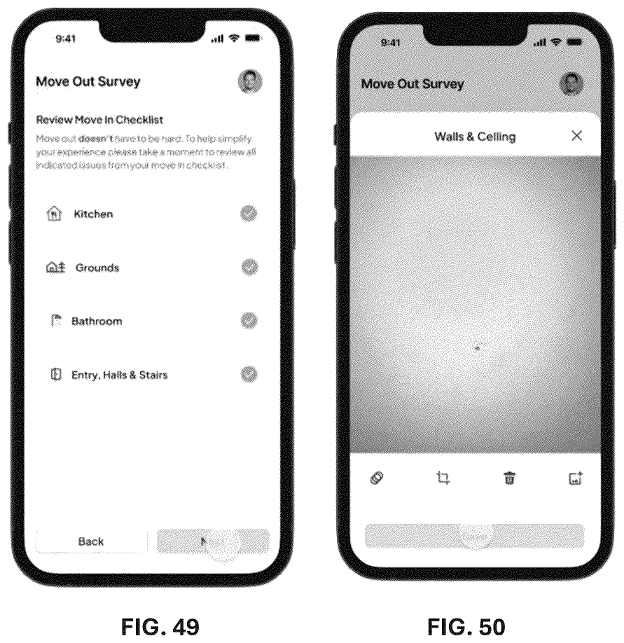

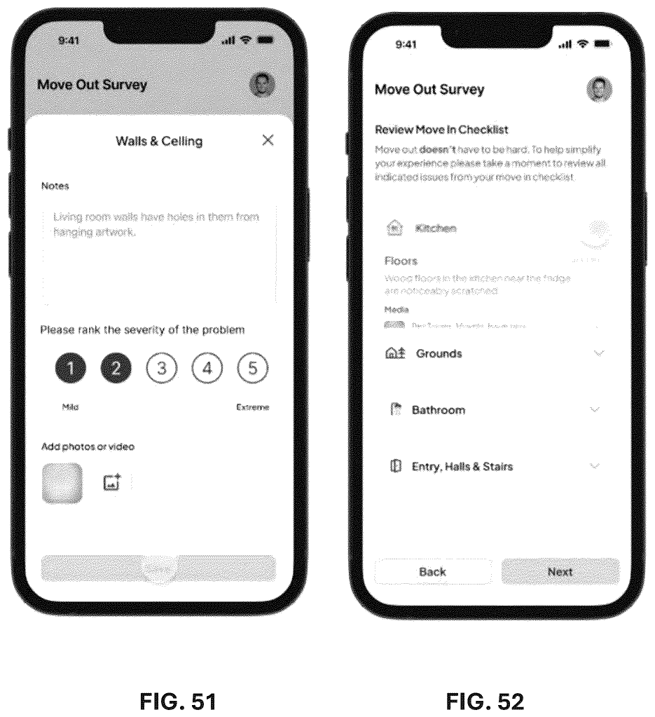

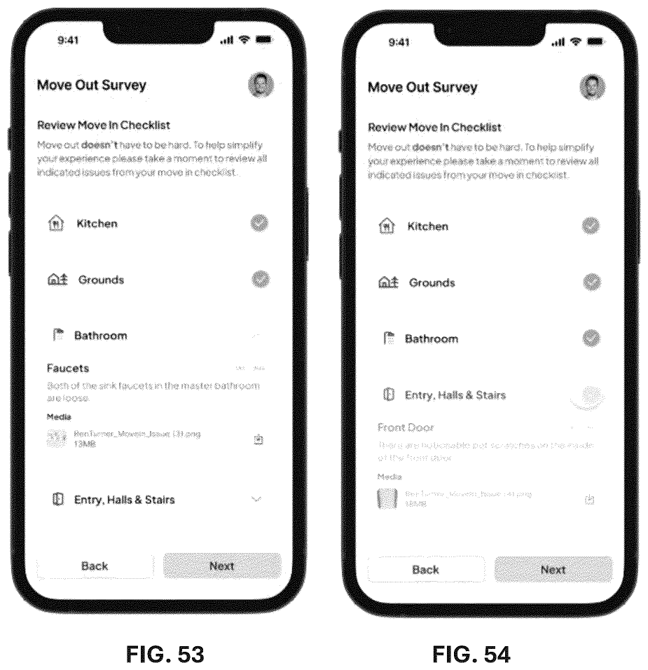

FIGS. 43-56 illustrate an example of a Move-Out inspection. In a manner similar to or the same as the Move-In inspection and periodic inspection during the occupied period, the provider platform can send an invitation and/or a message to the tenant, without a request from the tenant, via a tenant application, text message, email, instant messaging, and/or other in-app messaging, etc., as shown for example in FIGS. 43 and 44. In an example, the invitation can include a link for the tenant to complete a Move-Out inspection and provide a link to begin the tenant submission. Similar to the Move-In and periodic inspections, the tenant application can prompt the tenant to complete the Move-Out Survey. The tenant application can ask the tenant to notify or identify to the property owner a status of one or more items associated with the property, such as any items that are damaged or in need of repair, a condition of any items, etc. In an example, the tenant application provides the same pre-populated list of items associated with the property as in the Move-In inspection and/or one or more periodic inspections. However, in other examples, the tenant application can provide a different pre-populated list (i.e., with one or more different items from prior inspections), permit the tenant to enter items to be listed or added to a pre-populated list, or to select items to be listed from a template or sample list of items. In the example illustrated in FIGS. 45-54, the tenant application can prompt the tenant to complete a Move-Out checklist by indicating whether any new issues exist that were not included in the Move-In checklist. In this example, the graphic user interface of the tenant application prompts and guides the tenant through a video walk-through and asks the tenant to notify or identify any issues similar to the Move-In Inspection and/or periodic walk-through, capture and/or upload image data, such as photos and/or video, and provide comments and/or descriptions, among other things. In an example, the tenant application enables the tenant to review a baseline from their Move-In checklist, thereby fostering accountability. The tenant application enables to the tenant to submit a final Move-out video of the vacant unit/property to request release of wealth built by the tenant, all or a part of their security deposit, etc.

After the tenant submission for the Move-Out inspection is submitted by the tenant to the provider application, the provider platform can provide the tenant submission to the property owner via the property owner application for assessment by the property owner. In an example, a copy of the submission can be provided to each of the parties. The property owner application can request an approval from the property owner to complete the Move-Out.

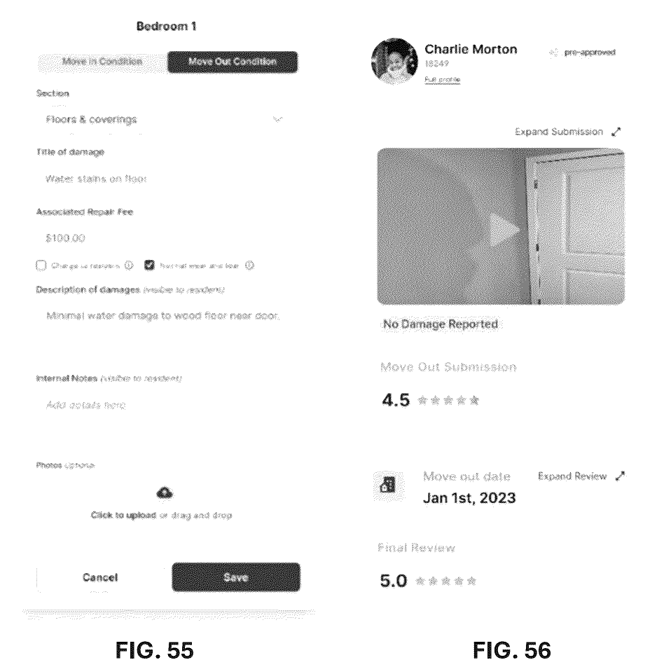

In an example, the provider platform can create a property manage facing Move-out submission. As shown in FIG. 55, the property owner application includes a graphic user interface that displays the contents and attachments of the Move-out submission. The property owner GUI also can provide additional information or analysis provided by the provider system, such as access to the Move-in submission, Move-out submission, and/or any periodic submissions. The property owner application can identify other information, such as particular areas or parts of the property, identification of damage and/or repairs for example for review by an inspector, associated repair fees (e.g., actual or estimated repair fees), descriptions of damage and/or comments/notes provided by the provider application, tenant, and/or property owner. Some of the fields can be configured to be visible to the tenant (e.g., fees associated with each repair) while other fields can be for viewing by the property owner and other stakeholders, such as property managers, only (e.g., notes for the property manager regarding repairs, inspections, etc.). The property owner application can be configured such that the property owner can upload image data, such as still image data and/or video image data, including without or with audio data. The property owner application can be configured such that the property owner can characterize any repairs or other issues as chargeable to the tenant (e.g., damage) or not chargeable to the tenant (e.g., normal wear and tear).

In some examples, the provider platform can assess the image data captured by the tenant and/or compare the image data captured by the tenant to stored image data captured in a prior submission or walk-through, such as a Move-In walk-through or a prior periodic walk-through, using, for example, one or more machine learning processes, such as one or more neural networks, such as transformer neural networks, NVIDIA DeepStream technology, etc. The provider application can be configured to analyze the captured image data, for example, to identify one or more issues (e.g., unreported issues, repairs or maintenance needed, etc.) based on a comparison with image data stored in a database, predict issues that may need attention based on trained models, etc., identify changes in a state of one or more items or areas from previous image data, among other things.

In some examples, the provider platform can assess the image data captured by the tenant to confirm that the property is vacant and/or clean, for example, prior to scheduling and/or arrival of a cleaning crew, maintenance personnel, etc.

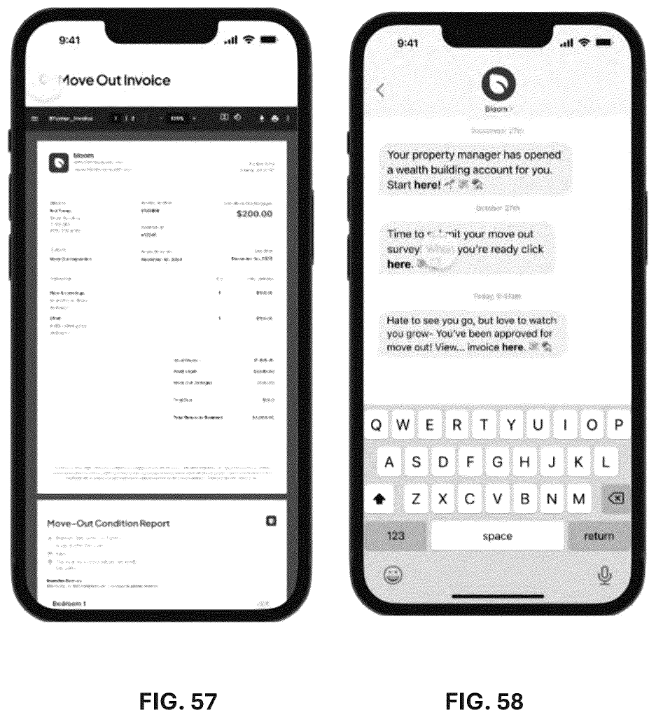

As shown in FIG. 56, the property owner application can display the contents and attachments of the Move-out submission, an assessment of reported and/or unreported issues, and other information such as the Move-out date, etc. In some examples, the provider platform can be configured to provide the Move-out submission to one or more interested parties or stakeholders, such as property managers. The provider application can leverage the tenant submissions and/or the property owner submissions in the Move-out submission to create one or more condition reports to assist maintenance teams, and/or generate (e.g., automatically generate) invoices for property owners and/or managers, etc. For example, as shown in FIG. 57, the provider application can generate a final invoice and/or a Move-out inspection report, among other things, and provide the same to the property owner application such that the property owner can review and approve the invoice.

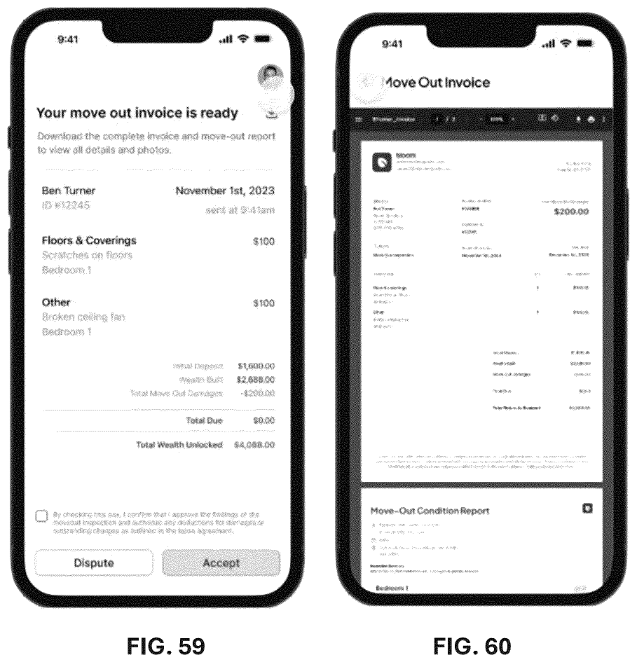

When the property owner enters an approval into the property owner application, the provider application can send a message to the tenant via the tenant application, text message, email, instant messaging, and/or other in-app messaging, etc., as shown for example in FIG. 58. The message can include a notification that the tenant has been approved for Move-out and/or a link for the tenant to view additional information. For example, the additional information can include one or more of an invoice (e.g., final invoice), security deposit utilization and/or balance, an amount or percentage of the security deposit applied to address one or more items, among other things. In the example shown in FIG. 59, the final invoice can include details (if any) of repair costs, an amount of the initial security deposit, wealth built by the tenant to date, total move-out damages, an amount due, and/or an amount of wealth unlocked for access by the tenant. The full report and/or final invoice, and any other attachments or information, can be visible to the tenant.

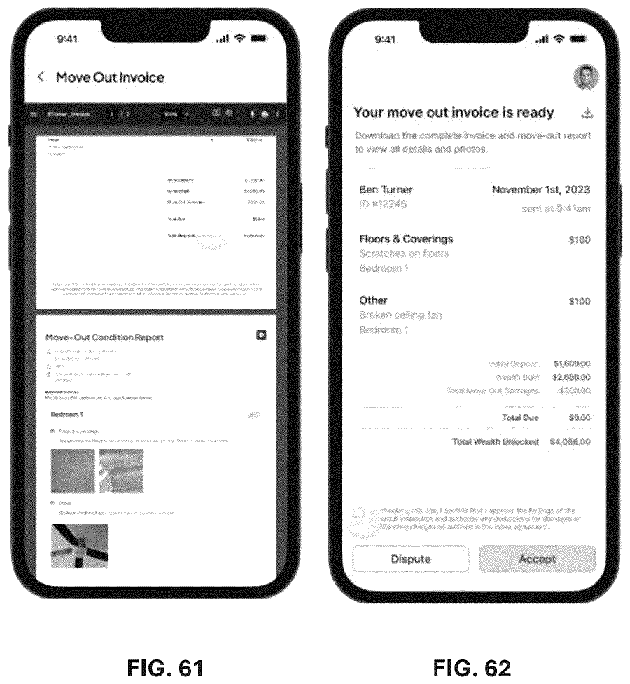

As shown in FIGS. 60-62, the tenant application provides the tenant with access to the final invoice and/or a Move-out inspection report, among other things, such that the tenant can review and accept or dispute the invoice. In some examples, the tenant application can enable the tenant to upload one or more image data, audio data, textual data, and/or comments for review by the property owner, for example, if the final invoice is disputed by the tenant.

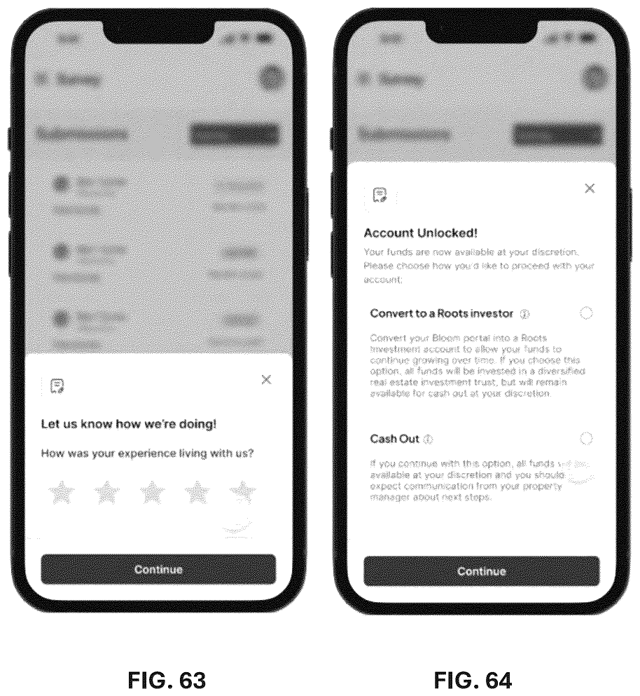

As shown in FIG. 63, the tenant application can prompt the tenant to provide a review of the property owner and/or property, their experience living in the property, among other things. This information and feedback can be used to generate one or more databases for use in other exemplary embodiments of the invention described below.

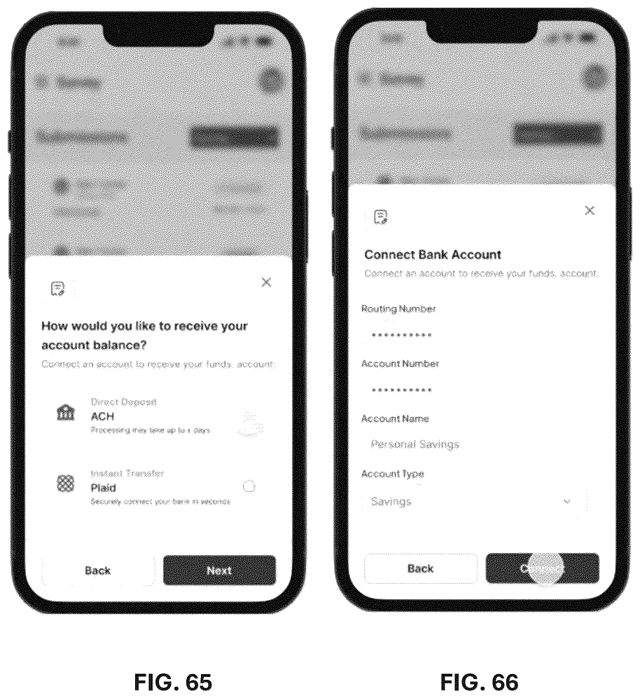

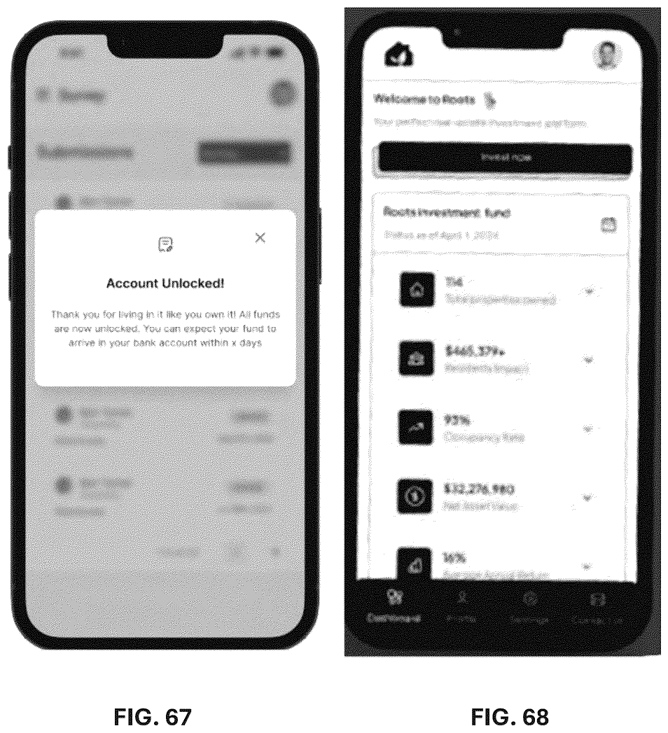

In an example, the provider application can include a payment processing and/or funds transferring module. For example, as shown in FIGS. 64-67, the provider application can be configured to provide options to the tenant application for receiving funds (if any) available to the tenant at Move-out. For example, the tenant can be provided one or more options to convert all or a portion of the balance of any generated wealth and/or security deposit into one or more investment accounts, such as a real estate investment trust, and/or to cash out all or a portion of the balance of any generated wealth and/or security deposit, as shown in FIG. 64. If the tenant elects to cash out, the tenant application can be configured to confirm the manner in which the tenant would like to receive the balance of the funds, such as via ACH transfer, Plaid, etc., as shown in FIG. 65. The tenant application can be configured to connect a bank account or other account to receive the funds, as shown in FIG. 66. The tenant application can be configured to complete the Move-out and confirm the election for payment of funds, as shown in FIG. 66.

In other examples, the provider application can be configured to transfer (e.g., automatically transfer) an amount (e.g., all or a portion) of the security deposit from a security deposit account for the tenant (e.g., an escrow account) to a predefined account of the tenant if any portion of the security deposit is owed to the tenant at Move-Out and/or to transfer (e.g., automatically transfer) an amount (e.g., all or a portion) of the security deposit from a security deposit account for the tenant (e.g., an escrow account) to a predefined account of the property if any portion of the security deposit is owed to the property owner at Move-Out.

### EXAMPLE 4

### Awards and Wealth Building

As explained in the examples above, when the tenant has completed entering all entries for the Move-In, periodic, and/or Move-Out inspection for the property, the tenant application can prompt the user to complete and submit the tenant submission to the provider application. When the tenant submission has been received by the provider platform, the provider platform can provide the tenant submission to the property owner via the property owner application. In some examples, the provider platform assess one or more factors, such as one or more of the status of one or more items of the property, the information provided by the tenant submission, the timing of the tenant submission, and other relevant information related to the tenant or the tenant submission, such as other tenant's and/or staff member interactions with the tenant and/or ratings of the tenant or the property occupied by the tenant, and analyze the one or more factors to determine one or more awards (e.g., an amount of one or more awards) to the tenant from the property owner.

In an example, the provider platform can assess the tenant submission and factors to provide assessment data to the property owner via the property owner application and/or a determination of one or more awards to be provided or attributed to the tenant, such as a Rebate. In some examples, the provider platform can assess the image data of the tenant submission using, for example, one or more machine learning processes (e.g., one or more neural networks) and/or one or more databases, and provide assessment data (e.g., a determined or predicted assessment) to the property owner via the property owner application. The property owner application can be configured to enable a property owner to approve or deny a rebate, auto approve rebates, etc.

In other examples, upon receipt of the tenant submission from the property owner application, the property owner can perform a calculation and/or determination of one or more awards to the tenant based on one or more of the status of one or more items of the property, the information provided by the tenant submission, the timing of the tenant submission, and other relevant information related to the tenant or the tenant submission, such as other tenant's and/or staff member interactions with the tenant and/or ratings of the tenant or the property occupied by the tenant. In some examples, the tenant application can be configured to provide the property owner with one or more options or selections for calculating an amount of a reward.

For purposes of the invention, an “award” can include any financial or other award including, for example, one or more of a rebate, cash or other monetary items having a fixed value, credits, debt reimbursement, discounts, products, services, ownership interest/equity investment stake in the property or another property or in a trust or fund for one or more properties such as share(s) in Real Estate Investment Trusts (“REITs”), stocks, etc., cryptocurrency, digital tokens, and/or other financial instruments having a fixed or variable value, or the like. The tenant and/or property owner applications can include an investment or ownership module, application, or the system can include a separate investment application for the tenant and/or property owner for obtaining an ownership interest/equity investment stake in the property and/or one or more other properties, for example, in a trust or fund for one or more properties such as share(s) in Real Estate Investment Trusts (“REITs”), stocks, etc. In an example, exemplary embodiments can be configured to transfer a portion or all of one or more awards of the tenant to one or more investment applications, such as a third-party investment application.

In an example, the tenant application provides the tenant with the determined award and/or an award report, among other things, such that the tenant can review and accept or dispute the award. In some examples, the tenant application can enable the tenant to upload one or more image data, audio data, textual data, and/or comments for review by the property owner, for example, if the award is disputed by the tenant.

In an example, the provider application can be configured to provide options to the tenant application for receiving awards (if any) available to the tenant. For example, the tenant can be provided an option to convert all or a portion of the balance of any generated awards into one or more investment accounts, such as a real estate investment trust. In another example, the tenant can be provided an option to add (e.g., automatically add) all or a portion one or more awards (e.g., monetary awards) to a security deposit of the tenant to provide additional protection for the tenant, as well as additional protection for the property owner. In still other examples, the provider application can be configured to transfer (e.g., automatically transfer) an amount (e.g., all or a portion) of an award to one or more investment accounts, such as a real estate investment trust, and/or a security deposit account for the tenant (e.g., an escrow account).

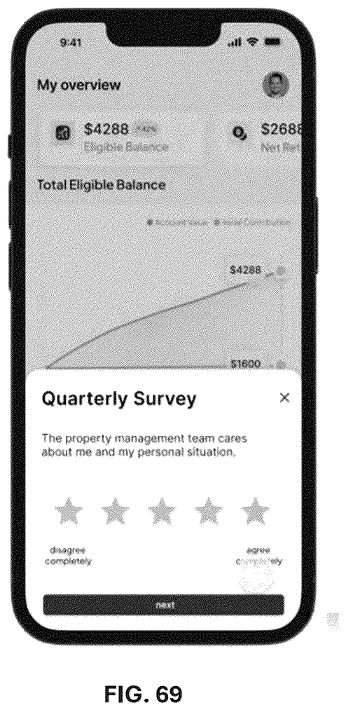

As shown in FIG. 68, in some examples, the tenant application can be linked to a tenant investment application to provide a summary of awards, funds, investments, etc. As shown for example in FIG. 69, the tenant application can be configured to provide information related to an award and/or an accumulation of awards (e.g., a total eligible balance).

With reference again to FIG. 69, examples of the tenant application can prompt the tenant to provide a review of the property owner and/or property, their experience living in the property, among other things, at one or more times throughout the various processes during the tenancy of the tenant. This information can be used to generate one or more databases for use in other exemplary embodiments of the invention described below.

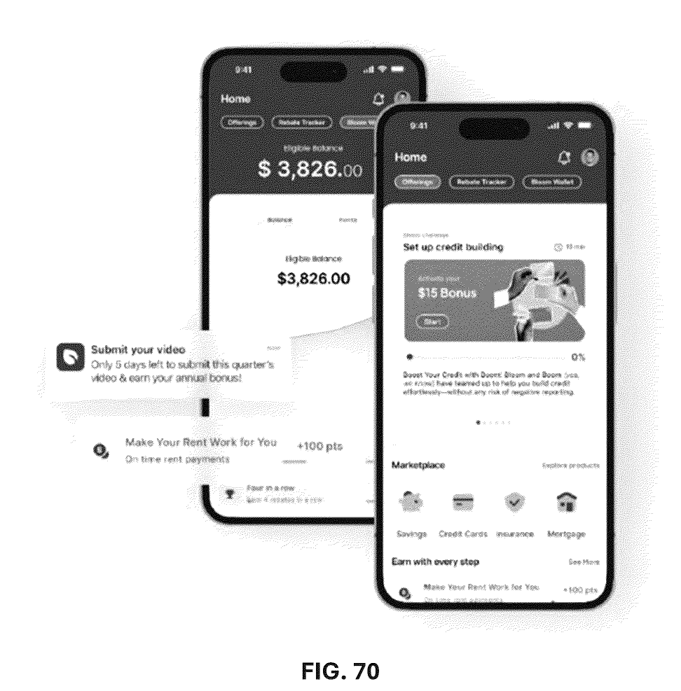

In other examples, an award can include other opportunities for the tenant and/or property owner (e.g., made available through the provider platform). For example, as shown in FIG. 70, an award can include one or more of financial offerings, marketplace offerings, access to investment funds, debt consolidation (e.g., enabling tenants to consolidate debit into a single loan with moderate interest rates, using a unique platform score beyond a typical credit score), savings (e.g., high yield savings including offering tenants access to FDIC insured, high yield savings alternative to a traditional savings account), credit, credit facilitation (e.g., enabling tenants to build credit and/or unlock access to credit with unique rewards tailored for renting and home ownership, credit cards, lending options, insurance options/discounts (e.g., renters, auto, life, disability, and/or other insurance), mortgage options/discounts, and/or community rates (e.g., community group rates). The tenant and/or property owner applications can include an Impact Marketplace module, application, or system in which a tenant and/or property owner can utilize awards and related data to access marketplace offerings. In an example, exemplary embodiments can be configured to transfer a portion or all of one or more awards of the tenant to one or more marketplace applications, such as a third-party marketplace application.

In some examples, the system can be configured to utilize awards and/or enhanced profits to make (e.g., automatically make) a contribution/donation (e.g., from one or more tenants, one or more property owners, and/or the provider platform) to the tenant community (e.g., a community fund, homeowner's association, etc.) for every one or more quotations obtained through the provider platform. In some examples, the system can be configured to utilize awards and/or enhanced profits to provide lending capital used to empower home ownership programs and tenant wealth building opportunities across one or more regions of the country. In some examples, the system can be configured to utilize one or more tenant submissions for investing in Environmental, Social, and Governance (ESG) programs that prioritizes environmental issues, social issues, and corporate governance. In examples, the system can be configured to utilize one or more tenant submissions to improve or open opportunities for ESG funding (e.g., government funding) to be deployed to better help those that ESG funds/investing are intended to help. In some examples, the system can be configured to utilize one or more tenant submissions to maintain or achieve compliance needs (e.g., government and/or agency compliance) and improve an impact (e.g., social impact) being made for tenants across a portfolio.

### EXAMPLE 5

### Wealth Building and Review Platform

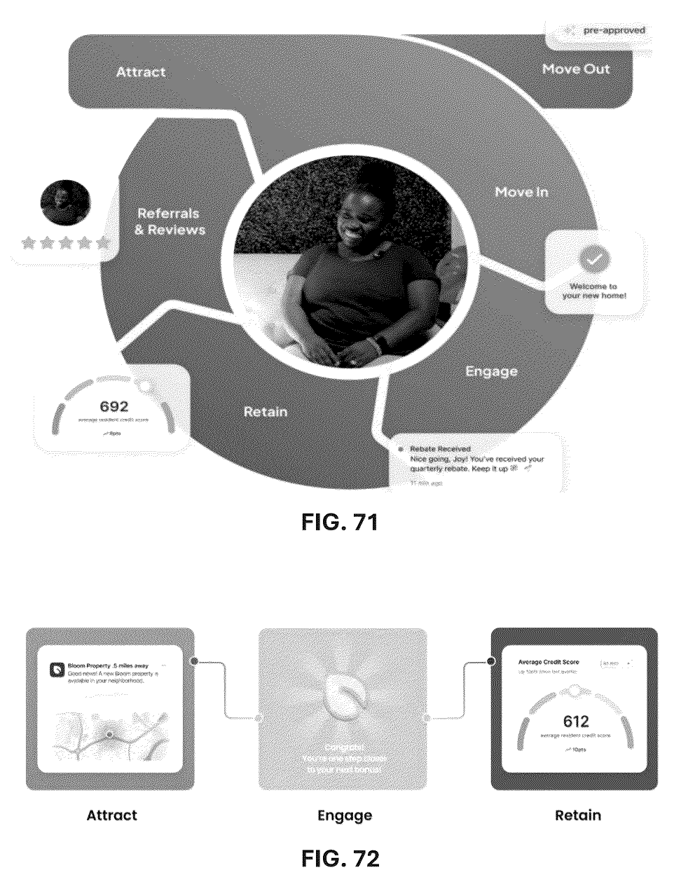

FIG. 71 illustrates an exemplary tenant/resident lifecycle. A conventional property owner has engagement with tenants in attracting tenants to rent properties and during move-in. However, after move-in, the property owner may have little engagement or interaction with the tenant until move-out. In contrast, the present invention provides property owners with the opportunity to engage tenants throughout the occupied period, such as through tenant submissions and awards issued to tenants. As a result, the exemplary embodiments of the invention enable a property owner to be actively engaged with the tenant in retaining tenants (e.g., retaining good tenants). Additionally, the exemplary embodiments of the invention enable a property owner to be actively engaged with the tenants in reviews and referrals.

As explained above, throughout the tenancy, the tenant application can prompt the tenant to provide a review of the property owner and/or property, their experience living in the property, among other things. In an example, a provider platform according to the present invention can collect data (e.g., tenant data, tenant submission data, property owner data, reviews of properties and/or property owners, etc.) and generate a database for assessing one or more tenants, properties, property owners, opportunities for tenant-property owner relationships (e.g., leasing or rental opportunities), etc. In some examples, the collected data can include reviews of tenants and/or property owners that are on-board the platform and/or tenants and/or property owners that are not on-board the platform.

The present invention can utilize such databases and assessments to combine traditional business development of creating partnerships with property owners and managers with a unique, innovative wealth-building and review platform accessible to tenants (and prospective tenants) across the country or parts of the country.

By growing a community of wealth-building tenants, the present invention can generate one or more databases and perform assessments using, for example, one or more neural networks, to identify and/or connect tenants with property owners, for example, who support their financial goals. In some examples, the present invention can generate one or more databases and perform assessments using, for example one or more neural networks, to identify and/or provide property managers and owners with access to tenants who are already engaged and invested in the process, for example, prior to Move-in, thereby assisting property owners in identifying tenants and filling vacancies faster. In this way, the present invention can attract tenants by providing a wealth-building review platform where tenants in one or more regions or nationwide can sign up, submit reviews, and build wealth while renting, thereby fostering a large-scale community.

In some examples, tenants can post reviews to an application of the wealth-building review platform. The application can be configured to enable engagement from tenants and/or property owners related to posted reviews.

In an example, the wealth-building review platform can send alerts or notices to tenants via a tenant application, text, etc. for available properties (e.g., nearby properties) of participating property owners. In some examples, tenants can use awards as an alternative to providing a security deposit, thereby easing the tenants transition to a new property. In an example, the wealth-building review platform can assess the tenant review data to attract property owners and managers, offering access to a growing pool of engaged tenants. In other examples, tenants can invite property owners and managers to join the wealth-building review platform, thereby improving upkeep and relationships between tenants and property owners.

In other examples, the present invention can generate one or more databases including one or more tenants without any prior engagement with participating property owners. For example, the wealth-building review platform can provide, for example, assessments, referrals, and/or recommendations of one or more tenants already on-board the platform and/or that are not on-board the platform to participating property owners on the platform. In other examples, the wealth-building review platform can provide, for example, assessments, referrals, and/or recommendations of one or more tenants already on-board the platform and/or that are not on-board the platform to one or more non-participating property owners. Similarly, in other examples, the wealth-building review platform can provide, for example, assessments, referrals, and/or recommendations of one or more property owners already on-board the platform and/or that are not on-board the platform to participating tenants on the platform. In other examples, the wealth-building review platform can provide, for example, assessments, referrals, and/or recommendations of one or more property owners already on-board the platform and/or that are not on-board the platform to one or more non-participating tenants.

With reference to FIG. 72, the exemplary embodiments of the invention described herein can attract tenants, promote engagement between tenants and property owners, and/or maximize or improve retention of tenants for property owners.

### EXAMPLE 6

### Employer/Employee Platform

In another exemplary embodiment, the systems and methods provide employees with the same or similar investment opportunities as described herein. For example, an exemplary embodiment provides a first party, such as an employer, organization, business, among other parties to provide awards, such as wealth building rewards, among other rewards, to a second party, such as an employee, customer, patron, participant in an organization, among other second parties, in exchange for the second party completing one or more challenges, for example, over one or more predetermined periods of time. In this way, the exemplary embodiments provide a system of and method for incentivizing a second party, such as a tenant, renter, employee, customer, patron, and/or participant in an organization, among other second parties, to complete one or more challenges, actions, tasks, and/or steps over one or more predetermined periods of time in exchange for a first party, such as a property owner, employer, organization, and/or business, among other first parties, to provide one or more awards, such as one or more wealth building rewards, among other rewards. The exemplary embodiments provide a party with a path to financial success, utilizing the exemplary platform, that builds wealth, strengthens loyalty, and/or incentivizes or elicits one or more actions and/or behaviors and/or other activities from one or more parties.

### EXAMPLE 7

### Wealth Building Rewards System and Method for Renters/Tenants and Property Owners

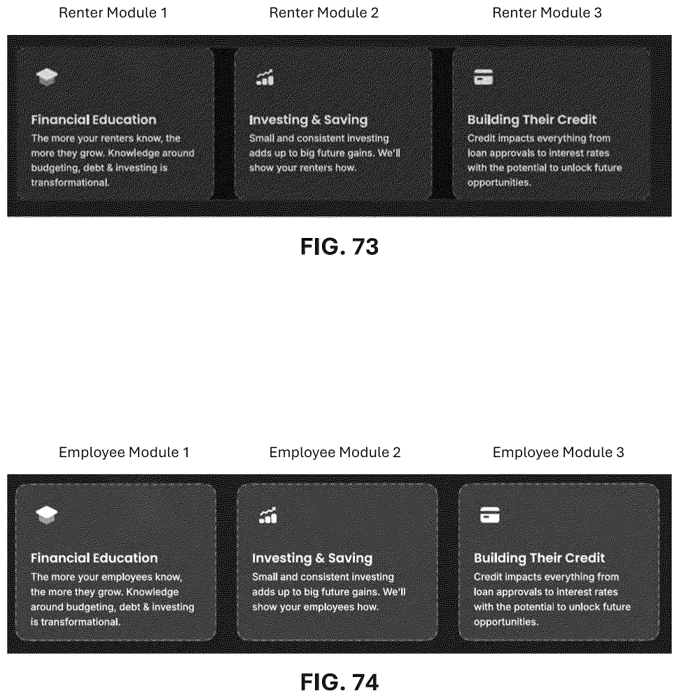

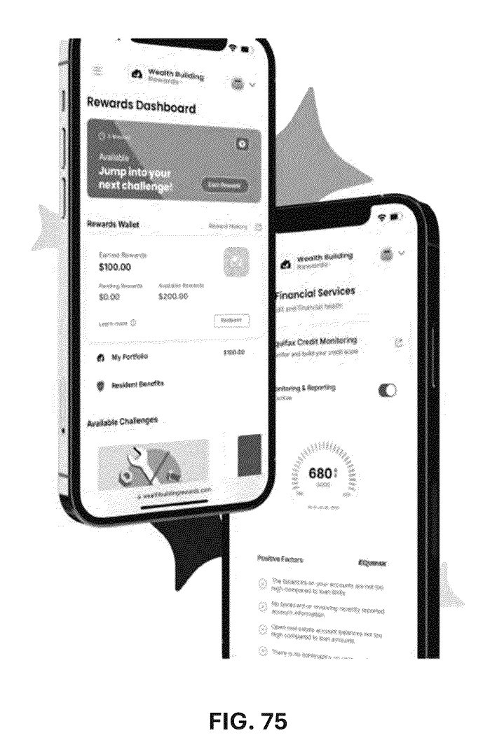

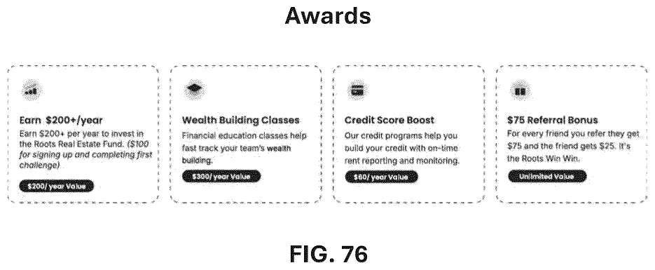

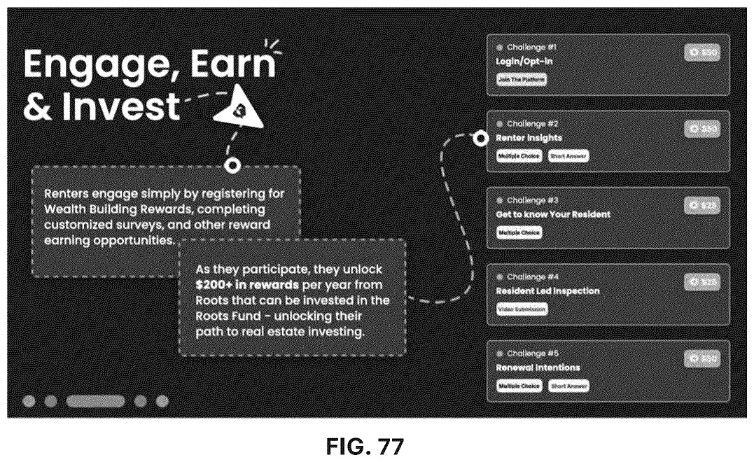

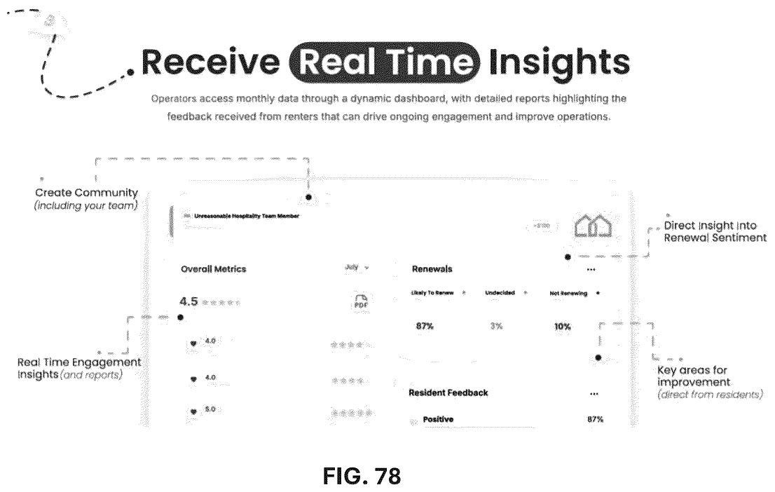

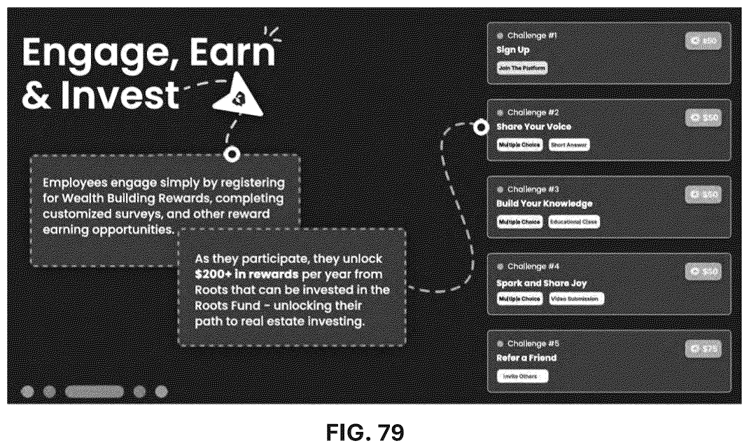

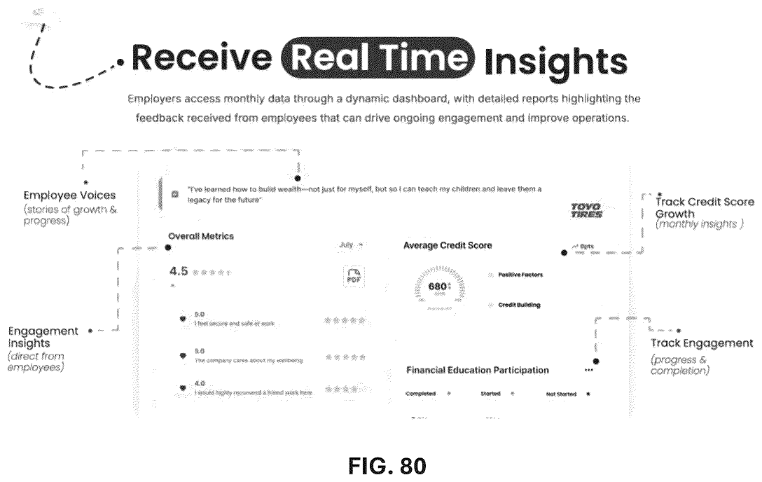

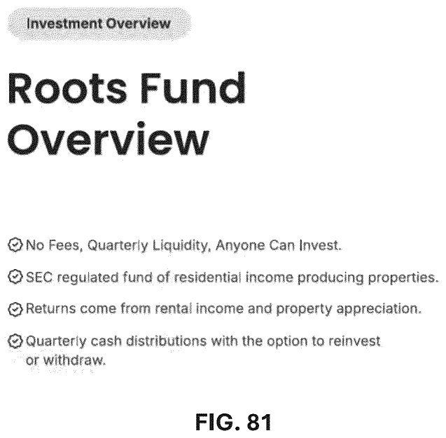

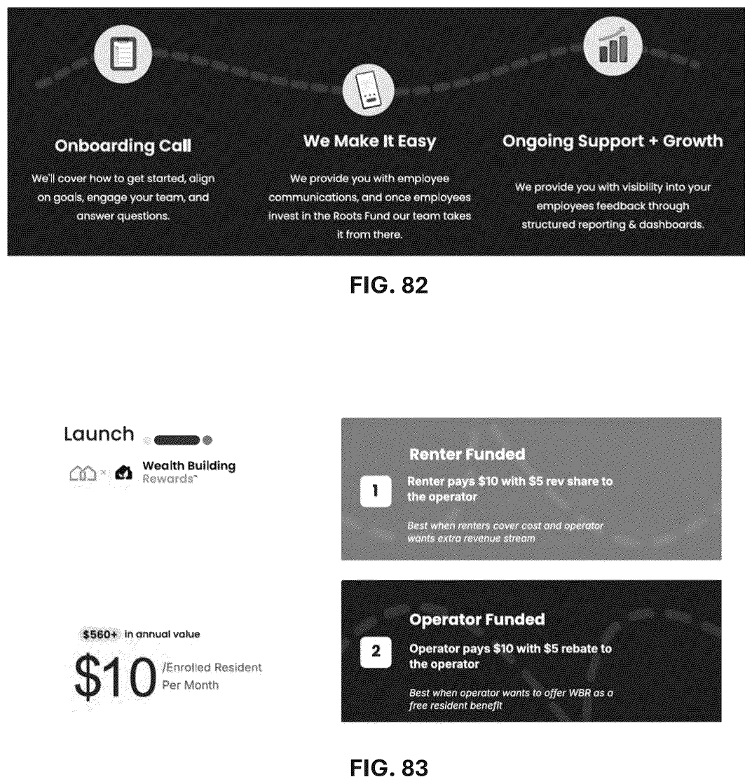

With reference to FIGS. 73-83, an exemplary embodiment of systems and methods for providing a Wealth Building Rewards program for renters focused on incentivizing renters to engage, provide feedback, and participate in property inspections. In the example, renters/tenants register for WBR, complete surveys, participate in resident-led inspections (e.g., including video submissions), and earn rewards (e.g., over $200/year). Rewards can be invested in the Roots Fund, with similar investment features as the employee program. Operators (e.g., property managers) can fund or share revenue from the program. Renters receive financial education, credit monitoring, and/or reporting benefits. Operators access engagement and feedback data via dashboards and reports. Referral bonuses and renewal intention tracking are included. In this way, the exemplary embodiments of systems and methods increase renter engagement, improve property care, and incentivize timely rent payments.

### EXAMPLE 8

### Wealth Building Rewards System and Method for Employees and Employers

With reference again to FIGS. 73-83, exemplary embodiments of systems and methods of providing one or more Wealth Building Rewards (WBR) programs for employees will now be described. The exemplary systems and methods enable employees to earn financial rewards, for example, through engagement activities (e.g., surveys, challenges, referrals, or the like) and invest those rewards in a real estate fund (e.g., Roots Fund) or other investment opportunity. According to an exemplary embodiment, an employee registers for WBR, completes surveys/challenges, and earns rewards (e.g., over $200/year). One or more awards/rewards can be invested in the Roots Fund, a SEC-regulated real estate investment fund with quarterly liquidity and no fees. Financial education, credit monitoring, and/or reporting are included as benefits. Employers receive engagement and feedback data via dashboards and reports. Referral bonuses and credit-building incentives are offered. In this way, the exemplary embodiments of systems and methods improve employee financial health, engagement, and loyalty.

### EXAMPLE 9

### Wealth Building Rewards System and Method for Employees and Renters

In an exemplary embodiment, the systems and methods described herein are implemented as a Wealth Building Rewards (WBR) system and method for both employees and renters/tenants. The WBR systems and methods enable participants to engage with the platform by registering, completing customized surveys, participating in challenges, providing feedback, and conducting resident-led property inspections, including video submissions. As participants engage with the program, they earn financial rewards (e.g., which may exceed $200 per year) and may be invested in a real estate investment fund, such as the Roots Fund, other investment opportunity, or the like.

In an example, the investment fund is a SEC-regulated fund of residential income-producing properties, offering quarterly liquidity, no fees, and returns derived from rental income and property appreciation. Participants may receive quarterly cash distributions with options to reinvest or withdraw. The system may further provide financial education, credit monitoring, and reporting services to participants, supporting their financial health and credit-building efforts.

Employers and property operators may access engagement and feedback data through dynamic dashboards and structured reports, enabling ongoing engagement and operational improvements. Referral bonuses and incentives for timely rent payments may be included to further encourage participation and positive behaviors.

In examples, the WBR systems and methods may be funded by operators, renters, or a combination thereof, and optionally may include revenue-sharing models. The systems and methods may track one or more metrics, such as total invested funds, target annual returns, number of properties and doors managed, and participant savings and investments, or the like.

By integrating the WBR program into the platform, the systems and methods enhance participant engagement, incentivize property care and timely payments, and/or provide a pathway for employees and/or renters to build wealth through real estate investment, financial education, and/or credit improvement, or other things.

As described herein, in other exemplary environments, instead of completing a move out survey or the like, an exemplary embodiment of the systems and methods provide one or more challenges to be completed by one or more second parties in exchange for one or more awards from one or more first parties, thereby providing a mechanism for a first party to incentivize or elicit one or more actions and/or behaviors and/or other activities from one or more second parties.

Similar to the exemplary embodiment illustrated in FIG. 1, another exemplary system framework includes an investment fund platform or application, a platform or application partnering employees and employers, and a platform or application for providing impact in the employment marketplace or other marketplace. The applications can be provided individually or as part of a monolithic application (e.g., web application). An exemplary system includes a provider platform (e.g., “provider application programming interface (API),” “provider GUI,” etc.) in communication with one or more employee applications (e.g., “employee API,” “employee GUI,” etc.) and one or more employer applications (e.g., “employer API,” “employer GUI,” etc.). The provider platform can include one more servers in communication with one or more computing devices, the one or more servers including one or more processors and one or more non-transitory computer-readable storage mediums storing one or more instructions comprising one or more algorithms that when executed by the one or more processors cause the one or more processors to perform one or more steps. The one or more servers can include one more communication modules. The provider platform, employee application, and/or employer application can be accessed by an employee or employer, respectively, via one or more computing devices, such as a mobile device (e.g., smart phone, smart watch, etc.), laptop, notebook, desktop, and/or other computing device having a user interface and a communication module. The one or more computing devices can include one or more processors and one or more non-transitory computer-readable storage mediums storing one or more instructions comprising one or more algorithms that when executed by the one or more processors cause the one or more processor to perform one or more steps. The one or more computing devices can include one more communication modules.

### EXAMPLE 10

### Wealth Building Rewards Systems and Methods

With reference again to FIGS. 73-83, exemplary embodiments of systems and methods for providing a Wealth Building Rewards (WBR) program will now be described. The WBR systems and methods expand upon the system and method described herein for incentivizing engagement and wealth-building among tenants, employees, and property owners. The exemplary embodiments introduce enhanced award/reward structures, data-driven decision logic, and/or flexible funding models to further improve participant outcomes and/or operational efficiency.

### Expanded Reward Structures

In the exemplary embodiments, the WBR systems and methods offer a variety of rewards including, for example, one or more of:
Direct financial incentives (e.g., cash, rent credits);
Investment stakes in real estate funds (e.g., REITs);
Credits toward security deposits or future rent;
Referral bonuses for recruiting new participants; or
Credit-building incentives, such as reporting timely payments to credit bureaus; or
a combination of two or more thereof.

### Enhanced Data Collection and Assessment

Participants interact with the platform by submitting one or more diverse data types, including, for example, one or more of:
Images, audio, and video documenting property conditions;
Survey responses and questionnaires;
Feedback on property management and engagement activities; or
a combination of two or more thereof.

The exemplary systems and methods process these submissions using, for example, one or more assessment algorithms, for example including one or more machine learning models (e.g., one or more neural networks) trained to identify, for example, property issues, evaluate engagement, and/or quantify participant contributions, among other things.

### Automated Decision Logic and Award Determination

The exemplary systems and methods provide a platform that employs automated decision trees and flow charts, for example, to one or more of:
Assess property status based on participant submissions;
Determine appropriate rewards based on engagement level, property condition, and other criteria;
Escalate issues to property owners or operators when maintenance is required; or
Trigger notifications and award distributions; or
a combination of two or more thereof.

With reference to the examples illustrated in the figures, an exemplary method starts (e.g., S2) with a step of receiving a submission (S4), a step of assessing data (e.g., utilizing one or more algorithms/neural networks) (S6), and a step of assessing and/or determining if a property condition is satisfactory (S8). According to the exemplary method, if the property condition is not determined to be satisfactory (S10), then an operator and/or maintenance personnel are notified (S12). According to the exemplary method, if the property condition is determined to be satisfactory (S14), then the system calculates, for example, an engagement score, or the like (S16) and determines, for example, one or more of a reward type and/or amount (S18), distributes the reward (S20), and updates one or more databases (S22), thereby ending this phase of the process (S24).

### Example Decision Tree:

If submission includes image/video and engagement score>threshold:
   Award investment stake+financial incentive
If property issue detected:
   Notify operator, withhold reward until resolved
If referral submitted and new participant joins:
   Award referral bonus
If timely rent payment is confirmed:
   Report to credit bureau, award credit-building incentive

### Participant Roles and Interactions

Tenants: Submit property status data, participate in surveys, earn rewards, and build credit.

Property Owners/Operators: Fund rewards, access engagement data, and manage maintenance issues.

Employees: Engage in challenges, provide feedback, invest rewards, and access financial education.

Employers/Operators: Fund rewards, access engagement data, and manage maintenance issues.

The exemplary embodiments are not limited to particular participant roles or interactions, and participant roles or interactions can include one or more combinations of one or more participant roles or interactions described herein.

### Flexible Funding and Revenue Sharing

Some exemplary embodiments include operator-funded rewards, participant-funded investments, and/or revenue-sharing models. Some exemplary systems and methods provide a platform configured to aggregate data across properties for portfolio-level analysis, enabling predictive maintenance and operational optimization.

### Portfolio Analysis and Predictive Maintenance

In some examples, the exemplary systems and methods are configured to analyze historical data and trends across multiple properties to, for example, one or more of:
Identify maintenance needs before issues arise;
Optimize reward structures based on engagement patterns; or
Provide actionable insights to property owners and operators; or
a combination of two or more thereof.

### Example Embodiment Scenarios

Example A: A tenant submits a video inspection of their apartment, receives an engagement score, and is awarded an investment stake in the Roots Fund.

Example B: An employee completes a financial education module, earns a reward, and invests it in a real estate portfolio.

Example C: A property operator funds the WBR program, shares revenue from increased engagement, and receives dashboard reports on participant activity.

With reference again to the illustrated figures, the exemplary systems and methods can be integrated with the core WBR platform described herein, thereby leveraging the same or similar technical infrastructure (e.g., servers, databases, and/or applications, among other things) and expanding the scope of participant engagement, reward determination, and/or operational analytics.

In an exemplary embodiment, a system and method enables employers (or other first parties) to provide employees (or other second parties) with investment opportunities and wealth building rewards, analogous to those described for property owners and tenants. This exemplary embodiment relates to a system and method for enabling a first party, such as an employer, organization, business, and/or other entity, to offer awards, including wealth building rewards, to a second party, such as an employee, customer, patron, and/or participant, in exchange for the second party completing one or more challenges, actions, tasks, and/or steps over one or more predetermined periods of time. The system is designed to incentivize engagement, productivity, and positive behaviors, while providing the second party with opportunities to build wealth through investment vehicles, such as real estate funds, retirement accounts, or other financial instruments.

### System Architecture

First Party Portal: A web-based or mobile application interface for employers/organizations to create, manage, and/or monitor challenges, set reward parameters, and/or fund awards.

Second Party Portal: A web-based or mobile application interface for employees/customers/participants to view available challenges, track progress, submit evidence of completion, and/or claim rewards.

Challenge Engine: A backend module that schedules, tracks, and/or verifies completion of challenges, actions, and/or tasks over one or more predetermined periods.

Reward Engine: A backend module that calculates, allocates, and/or distributes awards based on challenge completion, engagement metrics, and/or other criteria.

Investment Platform Integration: Integration with investment vehicles (e.g., real estate funds, retirement accounts, and/or stock portfolios) to allow second parties to invest earned rewards.

Data Analytics & Reporting: Dashboards and reports for first and/or second parties to monitor engagement, challenge completion rates, and/or investment growth.

### Exemplary Process Flow

### 1. Challenge Creation and Assignment

The first party (e.g., employer/organization) creates one or more challenges, specifying, for example, one or more of:
Challenge description and/or objectives;
Required actions, tasks, and/or steps;
Timeframe for completion (predetermined period); or
Associated rewards (e.g., cash, investment credits, and/or wealth building rewards, among other things); or
a combination of two or more thereof.

Challenges are assigned to second parties (e.g., employees, customers, and/or participants, among other things) via the second party portal.

### 2. Challenge Participation and Completion

The second party receives notification of assigned challenges.

The second party completes the required actions, tasks, and/or steps within the specified timeframe.

Evidence of completion (e.g., survey responses, uploaded documents, and/or activity logs) is submitted via the portal.

### 3. Verification and Reward Allocation

The challenge engine verifies completion using automated or manual review.

Upon successful verification, the reward engine calculates and allocates the appropriate award to the second party.

The second party may choose to invest the reward in available investment vehicles via the integrated platform.

### 4. Monitoring and Reporting

The first and/or second parties have access to dashboards showing challenge status, reward history, and/or investment growth.

The system may provide periodic reports and/or analytics to optimize future challenges and/or reward structures.

### Example Flow Chart: Employer-Employee Wealth Building Rewards

1. Start
2. First Party Creates Challenge
3. Assign Challenge to Second Party
4. Notify Second Party of Challenge
5. Second Party Completes Challenge?
6. If No, then send Reminder/Extend Deadline
7. If Yes, then Second Party Submits Evidence
8. Verify Completion
9. Is Completion Verified?
10. If No, then notify Second Party of Incomplete/Request More Information
11. If Yes, then Calculate Reward
12. Allocate/Distribute Reward
13. Second Party Invests Reward (Optional)
14. Update Dashboards/Reports
15. End

### Example Decision Tree: Reward Determination

If challenge completed within timeframe:
   Calculate base reward
   If challenge exceeds expectations (e.g., early completion, high quality):
      Apply bonus multiplier
   Offer investment options for reward (e.g., real estate fund, retirement account)
If challenge not completed:
   No reward allocated
   Optionally, provide feedback or allow retry
If multiple challenges are completed in series:
   Aggregate rewards, offer tiered investment opportunities

### Exemplary Embodiment Scenarios

### A. Employee Wellness Challenge:

Employer creates a monthly wellness challenge (e.g., steps walked, health screenings).

Employees who complete the challenge receive investment credits in a real estate fund.

### B. Customer Loyalty Program:

Business offers rewards to customers who complete feedback surveys or participate in promotional events, with rewards investable in a managed portfolio.

### C. Organizational Engagement:

Non-profit organization incentivizes volunteers to complete training modules, awarding credits toward retirement accounts or other wealth-building instruments.

The exemplary embodiments provide an extension of the core wealth building rewards platform, leveraging the same technical infrastructure (servers, databases, portals, reward engines, investment integration) and expanding the scope to include any first party/second party relationship. The system is configured to, or configurable to, support a wide range of challenge types, reward structures, and investment options, thereby enhancing engagement and wealth-building opportunities for all participants.

According to the exemplary embodiments described herein, a platform is provided that helps renters/employees build wealth through real estate investments, financial education, and credit building. The platform offers a rewards system where renters/employees can earn up to $200 in investable funds by completing certain tasks within their first year. The system is customizable for property owners and employers, or the like, who can provide additional rewards and surveys to gather insights from renters or employees. In examples, the platform charges fee (e.g., a monthly fee such as a $10 monthly fee) with revenue being generated through this fee and a portion of the rewards being investible or permitted to be invested.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description herein should not be read as implying that any particular element, step, or function can be an essential or critical element that must be included in the claim scope. Also, none of the claims can be intended to invoke 35 U.S. C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S. C. § 112(f). Even under the broadest reasonable interpretation, in light of this paragraph of this specification, the claims are not intended to invoke 35 U.S. C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

What is claimed:

1. A system for enabling a first party to provide awards to a second party in exchange for the second party completing one or more challenges over one or more predetermined periods of time, comprising:
a provider platform comprising one or more servers, each server including one or more processors and one or more non-transitory computer-readable storage mediums storing instructions that, when executed, cause the processors to:
receive, via a second party portal executed on a second party computing device, submissions from the second party comprising evidence of completion of one or more assigned challenges;
process the submissions using one or more assessment algorithms to verify completion of the challenges;
calculate and allocate awards to the second party based on verified challenge completion and engagement metrics;
provide an interface for the first party to create, assign, and monitor challenges, set reward parameters, and fund awards;
integrate with one or more investment platforms to enable the second party to invest earned awards in financial instruments; and
generate and display dashboards and reports for the first and second parties showing at least one of challenge status, reward history, or investment growth, or a combination thereof.

2. The system of claim 1, wherein the first party is an employer, and the second party is an employee.

3. The system of claim 1, wherein awards comprise investment credits in at least one of a real estate fund, retirement account, or other financial instrument, or a combination thereof.

4. The system of claim 1, wherein the challenge engine is configured to assign at least one of wellness, financial education, or productivity challenges, or a combination thereof, to employees.

5. The system of claim 1, wherein the provider platform includes modules for at least one of financial education, credit monitoring, or reporting services, or a combination thereof, accessible to employees.

6. The system of claim 1, wherein the provider platform is configured to allow employers to at least one of customize challenge types, reward structures, or investment options, or a combination thereof, for employees.

7. The system of claim 1, wherein the provider platform is configured to aggregate engagement and feedback data from employees and generate dynamic dashboards and structured reports for employers.

8. The system of claim 1, wherein the provider platform is configured to support flexible funding models, including at least one of employer-funded rewards, employee-funded investments, or revenue-sharing arrangements, or a combination thereof.

9. The system of claim 1, wherein the provider platform is configured to track one or more metrics including at least one of total invested funds, target annual returns, number of employees participating, and employee savings and investments, or a combination thereof.

10. The system of claim 1, wherein the provider platform is configured to enable employees to receive quarterly cash distributions from invested awards, with options to reinvest or withdraw.

11. The system of claim 1, wherein the provider platform is configured to provide periodic reminders to employees for incomplete challenges and allow deadline extensions.

12. The system of claim 1, wherein the provider platform is configured to generate referral bonuses and credit-building incentives for employees who recruit new participants or make timely payments.

13. The system of claim 1, wherein the reward engine is configured to apply one or more bonus multipliers for at least one of early or high-quality completion, or a combination thereof.

14. A computer-implemented method for incentivizing a second party to complete one or more challenges over a predetermined period of time in exchange for awards from a first party, the method comprising:
receiving, by a provider platform, challenge assignments from the first party specifying at least one or more required actions, tasks, or steps, or a combination thereof, and associated rewards;
notifying the second party of assigned challenges via a second party portal;
receiving evidence of challenge completion from the second party;
verifying completion of the challenge using automated or manual review;
calculating and allocating awards to the second party based on challenge completion and engagement metrics;
enabling the second party to invest allocated awards in one or more investment vehicles via an integrated platform; and
updating one or more dashboards or reports, or a combination thereof, accessible to at least one of the first and second parties, or a combination thereof, to monitor at least one of engagement, challenge completion rates, or investment growth, or a combination thereof.

15. The method of claim 14, wherein the first party is an employer, and the second party is an employee.

16. The method of claim 14, wherein awards comprise investment credits in at least one of a real estate fund, retirement account, or other financial instrument, or a combination thereof.

17. The method of claim 14, further comprising assigning at least one of wellness, financial education, or productivity challenges, or a combination thereof, to employees.

18. A platform for facilitating award-based challenges between a first party and a second party, comprising:
a first party portal configured to allow the first party to at least one of create, manage, or monitor challenges, or a combination thereof, set reward parameters, or fund awards, or a combination thereof;
a second party portal configured to allow the second party to view at least one of available challenges, track progress, submit evidence of completion, or claim rewards, or a combination thereof;
a challenge engine configured to at least one of schedule, track, or verify, or a combination thereof, completion of challenges over one or more predetermined periods;
a reward engine configured to at least one of calculate, allocate, or distribute awards, or a combination thereof, based on at least one of challenge completion or engagement metrics, or a combination thereof;
integration with investment platforms to enable the second party to invest earned rewards; and
data analytics and reporting modules configured to generate one or more dashboards or reports, or a combination thereof, for monitoring at least one of engagement, challenge completion, or investment growth, or a combination thereof.

19. The platform of claim 18, wherein the first party is an employer, and the second party is an employee.

20. The platform of claim 18, wherein awards comprise investment credits in at least one of a real estate fund, retirement account, or other financial instrument, or a combination thereof.
